(19) United States
(12) Patent Application Publication
(10) Pub. No.: US 2012/0163256 A1
(43) Pub. Date: Jun. 28, 2012

(54) NETWORK SYSTEM AND USER DEVICE, CALL-PROCESSING DEVICE, AND NETWORK BRIDGE FOR THE SYSTEM

(75) Inventors: Sungsoo Kang, Daejeon (KR); Choon Sik Yim, Daejeon (KR); Jae Gak Hwang, Daejeon (KR)

(73) Assignee: ELECTRONICS AND TELECOMMUNICATIONS RESEARCH INSTITUTE, Daejeon (KR)

(21) Appl. No.: 13/334,231

(22) Filed: Dec. 22, 2011

(30) Foreign Application Priority Data
Dec. 23, 2010 (KR) 10-2010-0134044

(51) Int. Cl. H04L 12/66; H04W 88/16; H04W 4/00

(52) U.S. Cl. 370/310; 370/352

(57) ABSTRACT

Disclosed is a network system including: a transmitting terminal dividing and transmitting data into a plurality of data pieces; a plurality of bridges each receiving the plurality of data pieces and transmitting the divided data pieces to the receiving terminal; and a call manager managing communication among the transmitting terminal, the receiving terminal, and the plurality of bridges, wherein the bridge uses the same identifier system as the transmitting terminal and the receiving terminal.

### CROSS-REFERENCES TO RELATED APPLICATIONS

The present application claims priority under 35 U.S.C 119(a) to Korean Application No. 10-2010-0134044, filed on Dec. 23, 2010, in the Korean Intellectual Property Office, which is incorporated herein by reference in its entirety set forth in full.

### BACKGROUND

Exemplary embodiments of the present invention relates to a network system, and more particularly, to a method for configuring a network by assigning a virtual address or an identification number and a structure thereof.

A system for providing voice communication to a consumer through Internet is referred to as a voice over Internet protocol (VoIP). A weak point of the VoIP may be very easily sniffed in a network including Internet. Further, sniffing may be made even in the case of transmitting voice or data information through a voice channel in mobile communication. For this reason, methods for encrypting voice or methods for performing authentication when an unauthenticated terminal tries to access a network have been proposed. These methods mainly focus on a method of encrypting data and decrypting the encrypted data using an authentication key and a method of preventing the unauthorized terminal from accessing the network. Therefore, all the contents of the transmitted information may be sniffed when the authentication key is leaked or when the packet sniffing is attempted through a simple access of the unauthenticated terminal to the network.

U.S. Pat. No. 7,230,921 B2 (Jun. 12, 2007) [Concurrent use of communication path in a multi-path access link to IP network] discloses an efficient method for transmitting data between nodes having a plurality of IP addresses. The method for transmitting data is a method for configuring a metric by periodically transmitting/receiving a heartbeat message for setting a source-destination pairs and transmitting information using the source-destination pair having the highest reliability based on the metric.

U.S. Pat. No. 6,829,215 B2 (Dec. 7, 2004) [IP multi-homing] has proposed a method of setting a preliminary switching virtual path between the existing LAN and WAN and changing to the preliminary switching virtual path when a failure in any one of the LAN and the WAN paths is sensed.

Even in the existing mobile phone, an asynchronous transfer mode virtual channel exchanger, or the like, when a first subscriber is on the phone to a second subscriber or the first subscriber and the second subscriber transmit information to each other, if a third subscriber requests a call for conversation to the second subscriber, various service methods of holding and waiting a call between the first subscriber and the second subscriber during communication, attempting a new call between the second subscriber and the third subscriber while placing the call with the first subscriber on hold, and again starting a previous call between the second subscriber and the first subscriber in a waiting state when a call between the second subscriber and the third subscriber is disconnected by the request of the second subscriber Korean Patent Laid-Open No. 10-2000-0039627 (Jul. 5, 2000); Korean Patent Laid-Open No. 10-2002-0048020 (Jun. 22, 2002), or the like). In addition, a method for registering desired subscribers by a mobile terminal user if necessary and selectively providing a call waiting service only to the registered subscribers has been proposed (Korean Patent Laid-Open No. 10-2004-0103690 (Dec. 9, 2004).

In addition, US Patent Laid-Open No. 2010/0015964 A1 (Jan. 21, 2010) or Korean Patent Laid-Open No. 10-2010-0008806 (Jan. 27, 2010) has proposed a method of changing a call in a waiting state during multi communication.

The contents show that a single terminal can be simultaneously connected with several subscribers even in the existing telephone network.

According to Document “Inverse multiplexing,” [Duncanson, J. IEEE Communications Magazine, Vol. 32, Issue 4, 1994, page 34-41], when there is a need to transmit 8M data, even though the existing transmitting apparatus has only a bandwidth of about 2M, a method of dividing the transmitting apparatus into four channels and performing transmission has been proposed. The technology disclosed in the Document is a technology referred to as inverse multiplexing that is a contrary inverse concept of multiplexing. Since the technology transmits data to a plurality of different transmitting apparatuses and paths, it is important to define a sequence of data transmitted through each of the transmitting apparatuses and paths.

U.S. Pat. No. 5,608,733 (Mar. 4, 1997) [ATM inverse multiplexing] as a method using the inverse multiplexing technology has proposed a method of sequentially transmitting an ATM cell to T1/E1 lines in a defined sequence, for example, a round robin manner by testing a state of a plurality of T1/E1 lines previously assigned and lines having good lines as a method of transmitting an ATM cell having capacity larger than that of a T1/E1 line and a bandwidth smaller than that of a T3/E3 line by using a plurality of T1/E1 lines.

In addition, US Patent Laid-Open No. 2010/006,738,6 A1 (Mar. 18, 2010) [Inverse multiplexing of digital data] has proposed a cell stuffing method as a method for solving a non-synchronized link problem when dividing and transmitting a high-speed ATM cell into a plurality of T1/E1 line by further extending the contents of U.S. Pat. No. 5,608,733.

U.S. Pat. No. 6,084,874 (Jul. 4, 2000) [Temporary data transfer connections] has proposed a method of directly transmitting data to a system requesting data if the system requesting a data transfer path can secure a desired level of data and transmitting data to a system through a broker system by allowing a system responding to data transmission to transmit data to the broker system if the system requesting a data transfer path cannot secure a desired level of data, by including a system requesting data transmission, a system transmitting data in response to the request, a system responding to the request, and at least one broker system so as to transmit a desired level of data using various communication paths such as a dedicated line between computer systems, a PSTN, a satellite link, Internet, or the like.

The method, which is a method of transmitting data in the state in which various communication lines are secured in advance, is not a method of allowing a node/terminal in which a transmitting/receiving channel is set to be one, to more safely transmitting data.

Document “Secure Data Transmission in Mobile Ad Hoc Networks,” [P. Papadimitratos and Z. J, Haas, ACM workshop on wireless security, San Diego, Calif., Sep. 19, 2003] has proposed a method of allowing two nodes to search possible paths between networks, selecting a multi-path, and dividing and transmitting information to be transmitted through the multi-path as a method of safe data communication between two nodes in a mobile ad-hoc network.

U.S. Pat. No. 7,710,869 B1 (May 4, 2010) [Packet routing to reduce susceptibility to disturbance] has proposed a method of allowing a router A to perform a change to another path when the quality of the used path is changed, as a method of testing characteristics of data when receiving data (voice, data, signaling information, or the like) from a caller, dividing the tested data into packets, numbering a series of packet sequence information, allowing a router B to reassemble divided packets based on the packet sequence information when dividing each packet through a plurality of paths and transmitting the divided packets to the router B and transmitting the reassembled packets to a called in a state in which the router A connected to the caller among the router in the network knows various paths between the router B connected to the called so as to safely transmit services such as voice over IP (VoIP) in an ad-hoc network while experiencing less disturbance or hindrance. The method does not mention a countermeasure against a case in which the caller and the called are a mobile terminal and a case in which anyone attempts sniffing between the caller and the router A and the router B and the called. In addition, the method can easily reassemble the packets when the packet sequence information transmitted by the router A is known.

U.S. Pat. No. 7,697,420 B1 (Apr. 13, 2010) [System and method for leveraging network topology for enhanced security] has proposed a method of detecting information of middle nodes between a source and a destination in an ad-hoc network, establishing some of a plurality of formable paths, dividing overall packet information to be transmitted into smaller packets having any length, transmitting the packets through different paths, and changing used middle paths into another path when predetermined time lapses to prevent the information of all the packets from passing through a single node.

Conventionally, when trying a node to node connection in a general public network or the Internet, the sender did not only have to know the internal paths for proper connection, but also had to send information about the paths used for the connection to work.

The above technology configuration is a background art for helping understanding of the present invention but does not mean the related art well-known in the art to which the present invention pertains.

When the related art is applied to a large-scale network such as a general public telecommunication network or Internet, the related art has a burden that nodes present at both terminals need to know internal path information of the large-scale network and since the internal information of the network is generally not transmitted to the terminals in a commercial network, it is difficult to apply the related art.

### SUMMARY

Exemplary embodiments of the present invention are to safely transmit voice/data information through a network without informing a terminal of internal information of a network while using the existing information protection method and apparatus as they are.

A network system includes: a transmitting terminal dividing and transmitting data into a plurality of data pieces; a plurality of bridges receiving the plurality of data pieces and transmitting the divided data pieces to the receiving terminal; a call manager managing communication among the transmitting terminal, the receiving terminal, and the plurality of bridges, wherein the bridge uses the same identifier system as the transmitting terminal and the receiving terminal.

In one embodiment, the call manager may select the plurality of bridges among the bridges present in the network system according to the number requested by the transmitting terminal.

In another embodiment, the plurality of data pieces each may have a correspondence relation corresponding to any one of the plurality of bridges and the receiving terminal recovers the data from the plurality of data pieces based on the correspondence relation.

In another embodiment, a sequence in which the plurality of data pieces and the plurality of bridges correspond to each other may be determined by the receiving terminal.

In another embodiment, an address of the receiving terminal may be previously stored in the call manager and the signal transmitted from the transmitting terminal to the call manager may not include the address of the receiving terminal and the signal transmitted from the receiving terminal to the call manager may not include the address of the transmitting terminal.

Another embodiment of the present invention relates to a user device including: a communication unit that allows wireless and wired communication within a network; and a processor processing data to be transmitted through the communication unit, wherein the processor is included in the network and is configured to receive information on the plurality of bridges using the same address system as the user device through the communication unit and is configured to divide the data into the plurality of data pieces and transmit the divided data pieces to the plurality of bridges, and the plurality of data pieces are configured to be transmitted to the receiving terminal by the plurality of bridges.

Another embodiment of the present invention relates to a user device including: a communication unit that allows wireless and wired communication within a network; and a processor processing data to be transmitted through the communication unit, wherein the processor is included in the network and is configured to receive information on the plurality of bridges using the same address system as the user device through the communication unit and after receiving the plurality of data pieces from the plurality of bridges, is configured to recover the data by combining the plurality of received data pieces.

In one embodiment, before the user device receives the plurality of data pieces from the plurality of bridges, the user device may randomly rearrange a sequence of the information on the plurality of bridges and transmit the information to the network and a process of combining the plurality of data pieces is executed according to a rearrangement sequence.

Another embodiment of the present invention relates to a call processing device including: a communication unit that allows wireless and wired communication within a network; and a processor processing transmitting data and receiving data transmitted and received through the communication unit, wherein the processor is configured to select a plurality of bridges from the network according to the number of bridges requested from a first user device and transmit the information on the plurality of selected bridges to the second user device and the plurality of bridges use the same address system as the address system of the first user device and the second user device.

Another embodiment of the present invention relates to a network bridge including: a communication unit that allows wireless and wired communication within a network; and a processor processing transmitting data and receiving data transmitted and received through the communication unit, wherein the processor is configured to receive information on a first user device and a second user device using the same address system as a network bridge from the network and is configured to receive data pieces from the first user device and transmit the received data pieces to the second user device.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram illustrating a voice/data transfer network structure to which an embodiment of the present invention may be applied;

FIG. 2 is a diagram illustrating a network structure for a wired VoIP terminal to which the embodiment of the present invention may be applied;

FIG. 3 is a diagram illustrating a network connected with wired nodes/terminals to which an embodiment of the present invention may be applied;

FIG. 4 is a diagram illustrating a network connected with wireless nodes/terminals to which an embodiment of the present invention may be applied;

FIG. 5A is a diagram illustrating a process of establishing a plurality of paths so as to divide and transmit voice/data into pieces in accordance with the embodiment of the present invention;

FIG. 5B is a diagram illustrating a process of releasing the plurality of paths established so as to divide and transmit the voice/data into pieces in accordance with the embodiment of the present invention;

FIG. 6A is a diagram illustrating an initial operation of an origination subscriber terminal/node in accordance with the embodiment of the present invention;

FIG. 6B is a diagram illustrating a process of allowing the origination subscriber terminal/node to transmit the voice/data in accordance with the embodiment of the present invention;

FIG. 6C is a diagram illustrating a process of allowing the origination subscriber terminal/node to receive the voice/data in accordance with the embodiment of the present invention;

FIG. 7A is a diagram illustrating a process of establishing a bridge of a call manager in accordance with the embodiment of the present invention;

FIG. 7B is a diagram illustrating a process of releasing the bridge of the call manager in accordance with the embodiment of the present invention;

FIG. 8A is a diagram illustrating a process of allowing the bridge to establish a relay function and delete from a table, in accordance with the embodiment of the present invention;

FIG. 8B is a diagram illustrating a process of allowing the bridge to relay the voice/data of the origination subscriber terminal/node in accordance with the embodiment of the present invention;

FIG. 8C is a diagram illustrating a process of allowing the bridge to relay the voice/data of the destination subscriber terminal/node in accordance with the embodiment of the present invention;

FIG. 9A is a diagram illustrating an initial operation of the destination subscriber terminal/node in accordance with the embodiment of the present invention;

FIG. 9B is a diagram illustrating a process of allowing the destination subscriber terminal/node to transmit the voice/data in accordance with the embodiment of the present invention;

FIG. 9C is a diagram illustrating a process of allowing the destination subscriber terminal/node to receive the voice/data in accordance with the embodiment of the present invention;

FIG. 10 is a diagram illustrating a process of transmitting and receiving access request signal/access request response signal without revealing address/identification number of an opponent when the path is established as illustrated in FIG. 5A in accordance with the embodiment of the present invention;

FIG. 11 is a diagram illustrating a process of transmitting and receiving messages without revealing the address/identification number of the opponent when the path is established as illustrated in FIG. 5B in accordance with the embodiment of the present invention;

FIG. 12 is a diagram illustrating a process of changing the number of bridges or the paths according to the need during the transmission of information by connecting an origination subscriber terminal/node with a destination subscriber terminal/node in accordance with the embodiment of the present invention; and

FIG. 13 is a diagram illustrating a process of releasing a relay of the bridge not used during the process of changing the number of bridges and the paths as illustrated in FIG. 12 in accordance with the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

Hereinafter, a network system, a user device therefor, a call processing device, and a network bridge in accordance with exemplary embodiments of the present invention will be described with reference to the accompanying drawings. In describing the embodiment, a thickness of lines illustrated in the drawings, a size of components, etc., may be exaggeratedly illustrated for clearness and convenience of explanation. In addition, terms described to be below are terms defined in consideration of functions in the present invention, which may be changed according to the intention or practice of a user or an operator. Therefore, these terms will be defined based on contents throughout the specification.

In describing components of the present invention, a ‘terminal/node’ may have the same meaning as a ‘terminal’ and may be referred to as a ‘user device’. In addition, an ‘origination subscriber terminal/node’ or an ‘origination subscriber terminal/node’ may have the same meaning as a ‘transmitting terminal’. In addition, a ‘destination subscriber terminal/node’ or a ‘destination subscriber terminal/node’ may have the same meaning as a ‘receiving terminal’. In addition, a ‘call manager’ and an ‘address/identification number manager’ may have the same meaning as a ‘call manager (CM)’ and a ‘call processing device’. In addition, ‘voice/data’ may be simply referred to as ‘data’. Further, an ‘address/identification number’ may be simply referred to as an ‘identifier’.

The embodiment of the present invention relates to a structure for safely transmitting information and a method thereof by establishing a plurality of bridges using the same identification number or address system as the subscriber terminal/node in the network and divides and transmitting the voice/data into pieces having a previously promised size to the bridges.

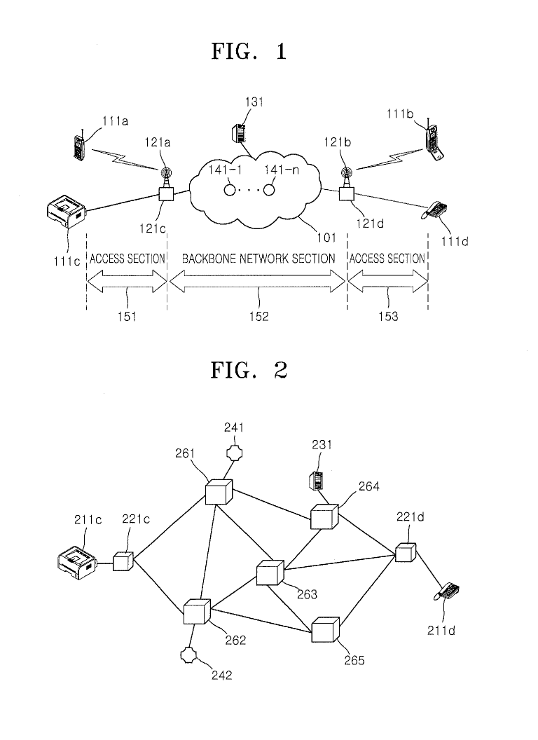

FIG. 1 illustrates a voice/network transfer network structure to which an embodiment of the present invention may be applied.

Referring to FIG. 1, wireless terminals/nodes 111a and 111b may be connected to existing backbone networks 101 and 152 including a public network and Internet by wireless and wired terminals/nodes 111c and 111c may be connected to the backbone networks 101 and 152 by a wired line. The wireless terminals/nodes 111a and 111b may be connected to base stations/wireless access points (AP) 121a and 121b by wireless. Hereinafter, the ‘base stations/wireless APs’ may be simply referred to as a ‘base station’. The wired terminals/nodes 111c and 111d may be connected to access nodes/wired APs 121c and 121d by a wired line. Hereinafter, the ‘access nodes/wired APs’ may be simply referred to as the ‘access node’. Hereinafter, the ‘wireless terminal/node’ and the ‘wired terminal/node’ may be collectively referred to as the ‘wireless/wired terminal/node’.

A bold line representing a connection of back bones 101 and 152, base stations 121a and 121b, and access nodes 121c and 121d represents ones having a bandwidth larger than an individual line bandwidth for connecting each wireless and wired terminal/node 111a, 111b, 111c, and 111d with an access node or wired/wireless APs 121a, 121b, 121c, and 121d and the backbone networks 101 and 152, the base stations 121a and 121b, and the access nodes 121c and 121d are connected to one another wirelessly or by a wired line. In addition, a device 131 is a device for determining whether a connection of each wired and wireless terminal/node 111a, 111b, 111c, and 111d is permitted when the wired and wireless terminal/nodes 111a, 111b, 111c, and 111d are connected to a network through access sections 151 and 153.

Bridges 141-1, . . . , 141-n may relay voice/data pieces for communication between the wired and wireless nodes 111a, 111b, 111c, and 111d by a request of the device 131 in the backbone networks 101 and 152 and may use the same identification number or address system as subscriber terminals/nodes such as the wired and wireless terminals/nodes 111a, 111b, 111c, and 111d.

FIG. 2 is a diagram illustrating a network structure for a wired VoIP terminal to which the embodiment of the present invention may be applied.

In FIG. 2, wired VoIP terminals 211c and 211d are the same as the wired terminals/nodes 111c and 111d of FIG. 1. In FIG. 2, intermediate nodes 261, 262, 263, 264, and 265 may perform a routing function in the backbone networks 101 and 152 of FIG. 1. In addition, a device 231 performs a function such as the device 131 of FIG. 1 and bridges 241 and 242 may perform a function such as bridges 141-1, . . . , 141-n of FIG. 1. The bridges 241 and 242 may be present in a module in the intermediate nodes 261 and 262 as illustrated as the example in FIG. 2 or may present as a separate node.

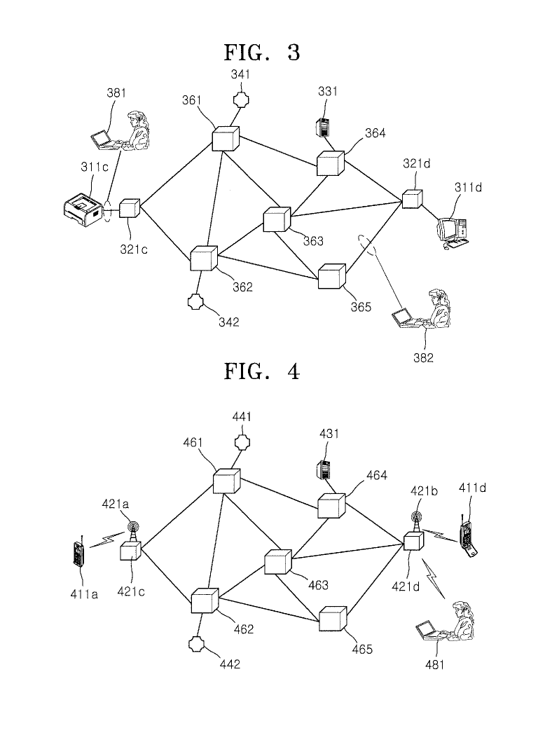

FIG. 3 is a diagram illustrating a network connected with wired nodes/terminals to which an embodiment of the present invention may be applied.

In FIG. 3, wired nodes 311c and 311d are the same as the wired terminals/nodes 111c and 111d of FIG. 1. In FIG. 3, intermediate nodes 361, 362, 363, 364, and 365 may perform a routing function in a backbone network in the backbone networks 101 and 152 of FIG. 1. In addition, a device 331 performs a function such as the device 131 of FIG. 1 and bridges 341 and 342 may perform a function such as bridges 141-1, . . . , 141-n of FIG. 1. The bridges 341 and 342 may be present in a module in the intermediate nodes 361 and 362 as illustrated as the example in FIG. 3 or may present as a separate node.

A terminal 381 is a terminal that has not received permission and FIG. 3 illustrates a case in which the terminal 381 is connected between the wired nodes 311c and 311d to monitor traffics between the wired nodes 311c and 311d. In addition, a terminal 382 is a terminal that has not received permission and FIG. 3 illustrates a case in which the terminal penetrates into the backbone network to monitor traffics between the wired nodes 311c and 311d transmitted through an access node 321d and an intermediate node 365.

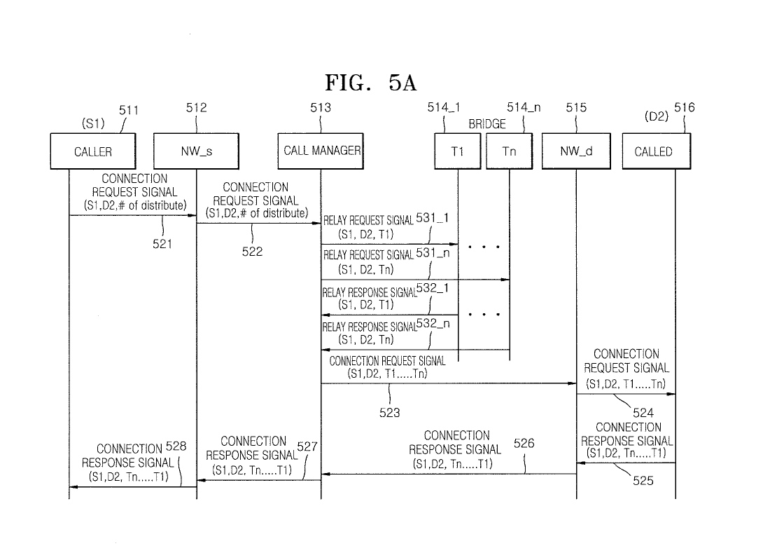

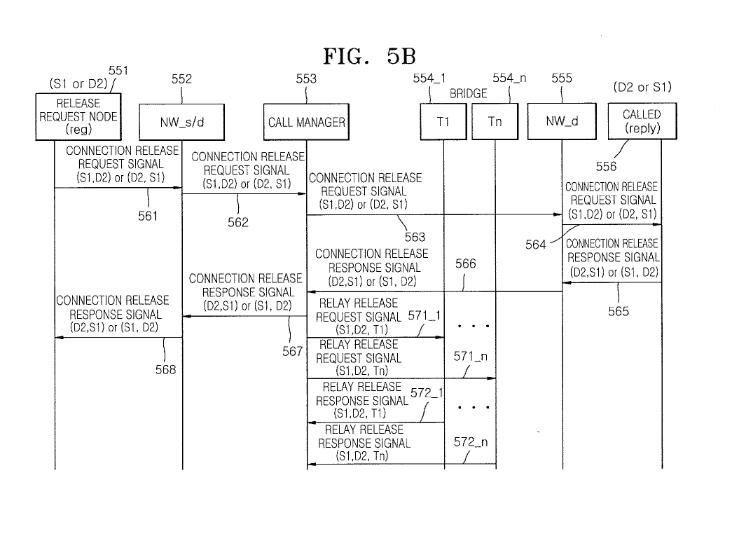

FIG. 4 is a diagram illustrating a network connected with wireless nodes/terminals to which an embodiment of the present invention may be applied.

In FIG. 4, wireless nodes 411a and 411b are the same as the wireless terminals/nodes 111a and 111b of FIG. 1. In FIG. 4, intermediate nodes 461, 462, 463, 464, and 465 may perform a routing function in a backbone network in the backbone networks 101 and 152 of FIG. 1. In addition, a device 431 performs a function such as the device 131 of FIG. 1 and bridges 441 and 442 may perform a function such as bridges 141-1, . . . , 141-n of FIG. 1. The bridges 441 and 442 may be present in a module in the intermediate nodes 461 and 462 as illustrated as the example in FIG. 4 or may present as a separate node.

In addition, in FIG. 4, base stations 421a and 421b have the same function as the base stations 121a and 121b of FIG. 1. A terminal 481 is a terminal that has been given permission and FIG. 4 illustrates a form in which the terminal 481 sniffs traffics between the base station 421b and the wireless node 411b.

FIG. 5A is a diagram illustrating a process of establishing a plurality of paths so as to divide and transmit voice/data into pieces in accordance with the embodiment of the present invention.

In FIG. 5A, a caller 511 corresponds to the wired terminal/node 111c of FIG. 1, the wired VoIP terminal 211c of FIG. 2, and the wired node 311c of FIG. 3 in the case of the wired terminal/node as the origination terminal or node (terminal/node) and corresponds to the wireless terminal/node 111a of FIG. 1 and the wireless node 411a of FIG. 4 in the case of the wireless terminal/node. In FIG. 5A, a called 516, which is a destination node/terminal to which the caller 511 is connected, corresponds to the wired terminal/node 111d of FIG. 1, the wired VoIP terminal 211d of FIG. 2, and the wired node 311d of FIG. 3 in the case of the wired terminal/node and corresponds to the wireless terminal/node 111b of FIG. 1 and the wireless node 411b of FIG. 4 in the case of the wireless terminal/node. In addition, in FIG. 5A, the access node/base station NW_s 512 may perform a function of connecting the caller 511 to the network. Hereinafter, the ‘access node/base station’ is may be referred to as an ‘access node’ or ‘NW_s’. The access node 512 corresponds to the access node 121c of FIG. 1, the access node 221c of FIG. 2, and the access node 321c of FIG. 3 in the case of the wired terminal/node and corresponds to the base station 121a and the access node 121c of FIG. 1 and the base station 421a and the access node 421c of FIG. 4 in the case of the wireless terminal/node.

In addition, in FIG. 5A, an access node/base station NW_d 515 may perform a function of connecting the called 516 to the network. The access node 515 corresponds to the access node 121d of FIG. 1, the access node 221d of FIG. 2, and the access node 321d of FIG. 3 in the case of the wired terminal/node and corresponds to the base station 121b and the access node 121d of FIG. 1 and the base station 421b and the access node 421d of FIG. 4 in the case of the wireless terminal/node.

Further, in FIG. 5A, a call manager (CM) 513, which is a device determining whether a connection of each terminal/node is permitted when the wired/wireless terminals/nodes are connected to the network through the access period, corresponds to the device 131 of FIG. 1, the device 231 of FIG. 2, the device 331 of FIG. 3, the device 431 of FIG. 4. In FIG. 5A, a module/server 514_1, . . . , 514_{—}n may serve to relay the data/voice information by the request of the call manager 513. Hereinafter, the ‘module/server 514_1, . . . , 513_{—}n’ may be referred to as ‘bridges 514_1, . . . , 514_{—}n. The bridges 514_1, . . . , 514_{—}n are the same as the bridges 141-1, . . . , 141-n of FIG. 1 and correspond to the bridges 241 and 242 of FIG. 2, the bridges 341 and 342 of FIG. 3, the bridges 341 and 342 of FIG. 3, and the bridges 441 and 442 of FIG. 4. For convenience, FIGS. 2, 3, and 4 illustrate only the two bridges.

In FIG. 5A, if the caller 511 is connected to the access node 512 for connecting with the called 516 to transmit a connection request signal 521 (configured by his/her own address/identification number S1, opponent address/identification number D2, and the number of request bridges, wherein the number of requests is randomly generated within a range permitted to the caller 511), the access node 512 transmits the same connection request signal 522 as the connection request signal 521 to the call manager 513 if it is determined that the caller 511 is a legal terminal/node. The call manager 513 receiving the connection request signal 522 selects the bridges 514_1, . . . , 514_{—}n managed by the call manager 513 if it is determined that the caller 511 is a legal terminal/node to transmit relay request signals 531_1 (configured by S1, D2, and T1), . . . , relay request signals 531_{—}n (configured by S1, D2, and Tn), respectively. In this case, relay request signals T1, . . . , Tn are the addresses/identification numbers of the bridges. The bridges 514_1, . . . , 514_{—}n receiving the relay request signals transmit a relay response signal 532_1 (configured by S1, D2, and T1), . . . , a relay response signal 532_{—}n (configured by S1, D2, and T2), respectively, to the call manager 513. When the call manger 513 receives all of the relay response signals 532_1, . . . , 532_{—}n, if the call manger 513 generates the connection request signal 523 (51, D2, T1, T2, . . . , Tn) and transmits the generated connection request signal 523 to the access node 515, the access node 515 transmits a connection request signal 524 that is the same signal as the connection request signal 523 to the called 516. When the called 516 receiving the connection request signal 524 randomly arranges a bridge sequence to generate the connection response signal 525 (S1, D2, Tn, . . . T1) and store the generated connection response signal 525 therein and transmit the connection response signal 525 to the access node 515, the access node 515 transmits the connection response signal 526 that is the same signal as the connection response signal 525 to the call manager 513 and when the call manger 513 stores the connection response signal 526 therein and transmits the connection response signal 527 that is the same as the connection response signal 526 to the access node 512, the access node 512 transmits the connection response signal 528 that is the same as the connection response signal 527 to the caller 511.

An example of a method different from the process of FIG. 5A as described above, there may be a method of allowing the call manager 513 to determine the arrangement sequence of the bridges rather than a method of allowing the called 516 to the arrangement sequence of the bridges. The method is a type of a category to which the present invention pertains.

FIG. 5B is a diagram illustrating a process of releasing the plurality of paths established so as to divide and transmit the voice/data into pieces in accordance with the embodiment of the present invention.

In FIG. 5B, a release request node/terminal 551 may be one of the caller 511 or the called 516 of FIG. 5A. Hereinafter, for convenience, the ‘release request node/terminal’ may be simply referred to as a ‘release request node’ or a ‘terminal’. In this case, when the release request node 551 is the caller 511 of FIG. 5A, an access node 552 corresponds to the access node 512 of FIG. 5A, an access node 555 corresponds to the access node 515 of FIG. 5A, and a called 556 corresponds to the called 516 of FIG. 5A. Hereinafter, the called 556 may be referred to as a ‘terminal’ for convenience. Further, when the release request node 551 is the called 516 of FIG. 5A, the access node 552 corresponds to the access node 515 of FIG. 5A, the access node 555 corresponds to the access node 512 of FIG. 5A, and the called 556 corresponds to the caller 511 of FIG. 5A. Further, the call manager 553 is the same as the call manager 513 of FIG. 5A and the bridges 554_1, . . . , 554_{—}n are the same as the bridges 514_1, . . . , 514_{—}n of FIG. 5A.

In FIG. 5B, in order to release the state in which the release request node 551 is connected with the called 556, when the connection release request signal 561 is transmitted to the access node 552, the access node 552 transmits the same connection release request signal 562 as the connection release request signal 561 to the call manager 553 if it is determined that the release request node 551 is a legal terminal/node. When the release request node 551 is the caller 511 of FIG. 5A, the release request node 551 generates the connection release request signals S1 and D2 and when the release request node 551 is the called 516, the release request node 551 generates the connection release request signals D2 and S1 and the call manager 553 can easily differentiate the case in which the caller 511 transmits the connection release request signal and the case in which the called 516 transmits the connection release request signal.

When the call manager 553 transmits the same connection release request signal 563 as the connection release request signal 562 to the access node 555, the access node 555 transmits the connection release request signal 564 that is the same as the connection release request signal 563 to the called 556. When the called 556 receiving the connection release request signal 564 generates the connection release response signal 565 and transmits the generated connection release response signal 565 to the access node 555, the access node 515 transmits the same connection release response signal 566 as the connection release response signal 565 to the call manager 553 and when the call manger 553 transmits the same connection release response signal 567 as the called 556 to the access node 552 and at the same time, generates a relay release request signal 571_1 (configured by S1, D2, and T1), . . . , a relay release request signal 571_{—}i (configured by S1, D2, and Ti), . . . , a relay release request signal 571_{—}n (configured by S1, D2, and Tn) and transmits the generated relay release request signal 571_1, . . . , relay release request signal 571_1, . . . , a relay release request signal 571_{—}n to the bridges 554_1, . . . , 554_{—}i, . . . , 554_{—}n performing a relay role between the release request node 551 and the called 556, the bridges 554_1, . . . , 554_{—}i, . . . , 554_{—}n transmits the relay release response signal 572_{—}i (configured by S1, D2, and T1), the relay release response signal 572_{—}n (configured by S1, D2, and T2) to the call manager 553. The call manager 553 receiving all the relay release response signal 572_1, . . . , 572_{—}n removes the connection response signal (526 of FIG. 5A) stored therein. In addition, the access node 552 receiving the connection release response signal 567 transmits the same connection release response signal 568 as the connection release response signal 567 to the release request node 551. When the called 556 is the caller 511 of FIG. 5A, the connection release response signals S1 and D2 are generated and when the called is the called 516, the connection release request signals D2 and S1 are generated, such that the call manager 553 can easily differentiate the case in which the caller 511 transmits the connection release request signal and the case in which the called 516 transmits the connection release request signal.

As an example of a method different from the process of FIG. 5B as described above, there may be a method of directly providing an actual behavior of the connection release to the bridge or a method for first transmitting the release signal to the opponent. However, the methods are different only in a sequence but are a type of a category to which the present invention pertains.

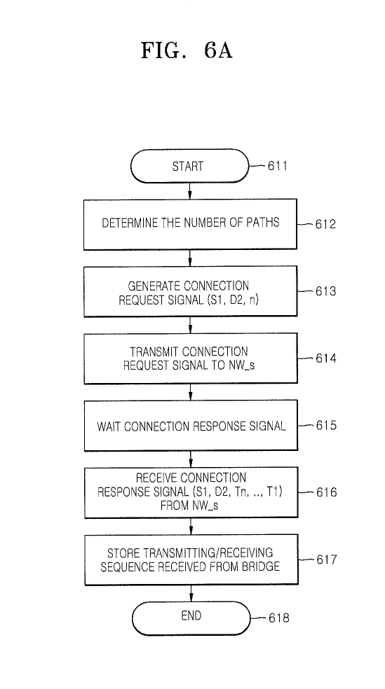

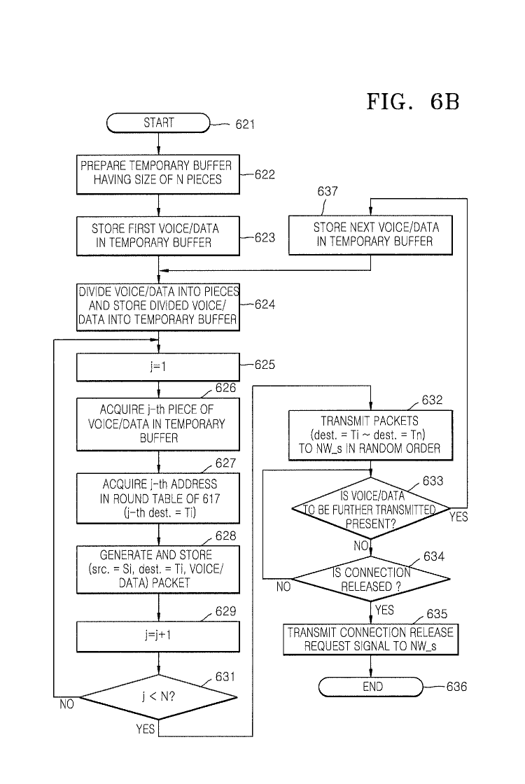

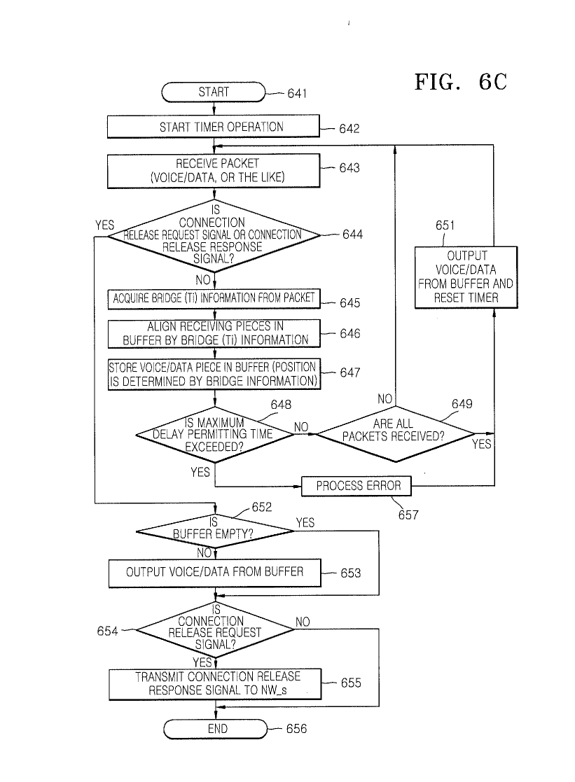

FIG. 6A is a diagram illustrating an initial operation of an origination subscriber terminal/node in accordance with the embodiment of the present invention.

Referring to FIG. 6A, in order to connect the caller 511 of FIG. 5A with the called 516 of FIG. 5A, connection initialization for connecting with the access node 512 of FIG. 5A starts (611). Then, the call manger 513 of FIG. 5A determines the number of paths randomly establishing the number of desired bridges within a range permitted to the caller 511 (612) and generates the connection request signals S1, D2, and n (521 of FIG. 5A) configured by its own address/identification number S1, an opponent address/identification number D2, and the number of bridges (herein, n) to be requested (613).

Then, the connection request signals S1, D2, and N are transmitted to the access node NW_s 512 (614) and the connection response signal (528 of FIG. 5A) waits from the access node NW_s 512 of FIG. 5A (615), and the connection response signals S1, D2, Tn, . . . , T1 are received from the access node NW_s 512 of FIG. 5A (616). Next, when transmitting/receiving the voice/data pieces by analyzing the bridge information signal from the received connection response signals S1, D2, Tn, . . . , T1, the bridge addresses/numbers to be used are stored in a round table in a sequence previously promised with the destination subscriber terminal/node (617). Thereby, the connection initialization step of the called 516 of FIG. 5A and the terminal/node completes (618).

The round table storing step (617) includes a maximum delay permitting time of a circulating cycle. In this case, the maximum delay permitting time of the circulation cycle refers to the whole permission time in which n packets are received when the number of bridges is n. In addition, the sequence previously promised with the above-mentioned destination subscriber means a sequence previously promised with an opponent about whether to use the bridge sequence to be used when the voice/data pieces are transmitted and received to and from the opponent subscriber terminals/nodes without changing the sequence of the bridge address/identification number information included in the connection response signal (528 of FIG. 5A) or about whether to use the bridge sequence by changing the sequence by other methods.

FIG. 6B is a diagram illustrating a process of allowing the origination subscriber terminal/node to transmit the voice/data in accordance with the embodiment of the present invention.

Referring to FIG. 6B, a process of transmitting voice/data starts (621). An temporary buffer capable of containing N voice/data pieces is prepared (622). Herein, N may be the number of bridges determined at step 617 of FIG. 6A. First voice/data information is stored in the temporary buffer at step 622 (623), the voice/data information is sequentially divided into N pieces 624, j is set to be 1 (625), and j-th voice/data piece is fetched from a j-th temporary buffer (626).

Then, a number/address of a j-th bridge is fetched from a round table stored at step 617 of FIG. 6A (627), a packet using a bridge selected at step 627 as a destination is generated and stored (628), and j is set to be j+1 (629). Next, a process proceeds to step 626 when being smaller than N, or proceeds to step 632, by testing whether j<n (N is the number of bridges at step 617) (631). Then, at step 628, the stored packets (N number) are transmitted in a random sequence (632) and it is tested whether the voice/data to be transmitted are further present (633), a process proceeds to step 637 if it is determined that the voice/data to be transmitted is present, and a process proceeds to step 634 whether there is no voice/data to be transmitted (634).

A process proceeds to step 633 when the connection is not released and a process proceeds to step 625 when the connection is released, by determining whether the connection state is released. When the connection is released, the caller 511 of FIG. 5A ends the transmission transmitted to the called 516 (636) by transmitting the connection release request signal to the access node 512 of FIG. 5A. When there is voice/data to be transmitted, the next voice/data information is fetched and is stored in the temporary buffer 637. A process returns to the next step (624).

FIG. 6C is a diagram illustrating a process of allowing the origination subscriber terminal/node to receive the voice/data in accordance with the embodiment of the present invention.

Referring to FIG. 6C, reception starts 641 and a timer operation starts (642). Then, the packet is received (643) and it is determined whether the contents of the received packets are the voice/data pieces or the connection release request signal (564 of FIG. 5B) or the connection release response signal (568 of FIG. 5B) (643). As the determination result, when the contents of the received packet is the voice/data pieces, a process proceeds to step 645 or proceeds to step (652). Next, at step 643, the bridge information Ti is informed in the received packet (645) and the position of the voice/data pieces is informed by the bridge receiving sequence stored in the table stored at step 617 of FIG. 6A (646).

Then, the voice/data pieces are stored at a corresponding position of the buffer (647) and it is tested whether the time of the timer starting the operation at step 642 tests exceeds the maximum delay permitting time set at step 617 of FIG. 6A. As the test result, when the contents of the received packet are the voice/data pieces, a process proceeds to step 649 or proceeds to step (657). Next, at step 617 of FIG. 6A, it is tested whether all the packets are received by the stored table (649). As the test result, when all the packets are received, a process proceeds to step 651 or proceeds to step 643. At step 651, the voice/data stored in the buffer are output and the timer time is initialized. Then, a process proceeds to step 643.

Step 657 of FIG. 6C corresponds to a case in which all the voice/data pieces are not received in the buffer of step 647 even when the maximum delay permitting time set at step 617 of FIG. 6A is exceeded. As the example, when the bridge through which the packets transmitted by the opponent passes are sequentially designated as in the bridges T3, T5, T2, T4, and T1, for any reason, only the bridges T3, T5, T2, and T1 are received and the bridge T4 is lost. In this case, a missed portion is displayed. Then, a process proceeds to step 651.

Then, it is tested whether the receiving buffer is empty (652). If it is determined that the buffer is not empty, a process proceeds to step 653 and if it is determined that the buffer is empty, a process proceeds to step 654. At step 653, all the voice/data pieces that are present in the buffer are output and at step 654, when the contents of the received packets are the connection release request signal (564 of FIG. 5B), a process proceeds to step 655 or proceeds to step 656. Step 655 is a step of transmitting the connection release response signal (565 of FIG. 5B) to the access node 512 and step 656 is a step of ending the receiving operation of the caller 511 of FIG. 5A.

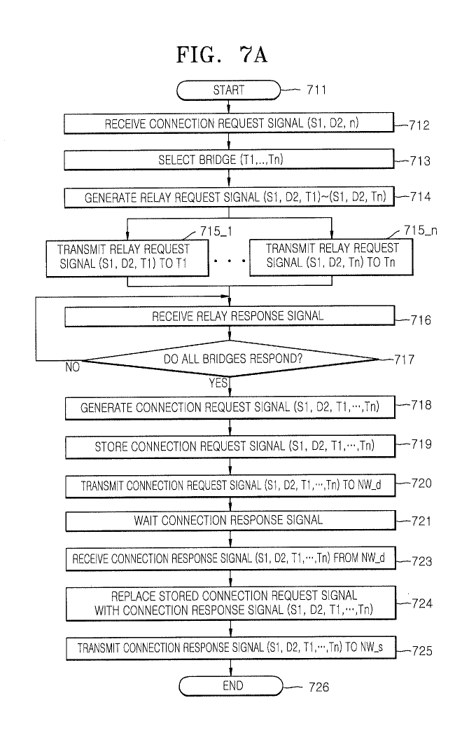

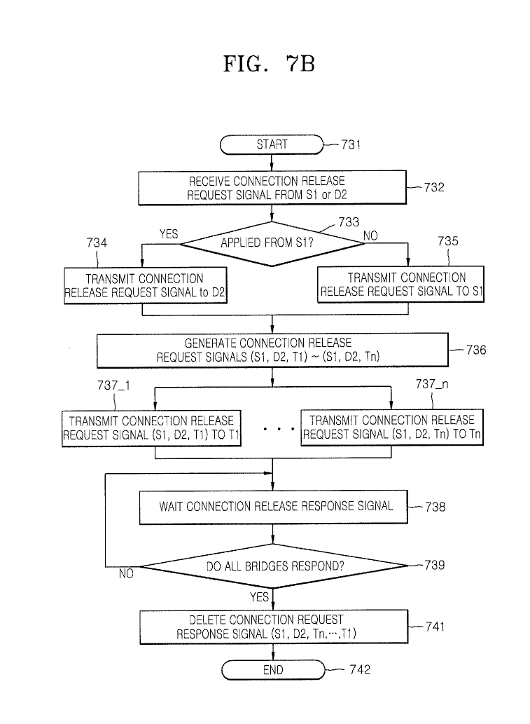

FIG. 7A is a diagram illustrating a process of establishing the bridge of the call manager in accordance with the embodiment of the present invention.

Referring to FIG. 7A, an operation starts (711) and the call manager 513 receives the connection request signal 521 transmitted by the caller 511 from the access node 512 of FIG. 5A (712). Then, if the number (n) of bridge requests is valid in the contents of the connection request signal 521, the call manager 513 can be used among the bridges managed thereby and selects the bridges T1, . . . , Tn that are different bridges (713). Then, the relay request signals S1, D2, and T1, . . . , S1, D2, and Tn to be transmitted to the selected bridges are generated (714).

At continued steps 715_1, . . . , 715_{—}n, the relay request signals (531_1, . . . , 531_{—}n) of FIG. 5A are transmitted to the bridges T1, . . . , Tn. Next, the relay response signal is received from the bridges T1, . . . , Tn (716) and it is tested whether all the relay response signals 532_1, . . . , 532_{—}n of FIG. 5A are received (717) As the test result, when all the relay response signals are received, a process proceeds to a step 718 or proceeds to a step (716). At step 718, the connection request signals S1, D2, T1, . . . , Tn included in the bridges are generated and at step 719, the connection request signal generated at step 718 is stored.

Next, a step of transmitting the connection request signal (523 of FIG. 5A) to the access node 515 of FIG. 5A to the called 516 of FIG. 5A is performed, step 722 waits the connection response signal (526 of FIG. 5A) for the connection request signal (523 of FIG. 5A) transmitted from step 721 (721), and the connection response signal (526 of FIG. 5A) is received (723). Next, the connection request signals S1, D2, T1, . . . , Tn stored at step 719 is replaced with the connection response signal (526 of FIG. 5A) and the connection response signal (527 of FIG. 5A) is transmitted to the access node 512 of FIG. 5A (725). As a result, an operation of receiving and processing the connection request signal 521 from the caller 511 of FIG. 5A completes (726).

FIG. 7B is a diagram illustrating a process of releasing the bridge of the call manager in accordance with the embodiment of the present invention.

Referring to FIG. 7B, an operation starts (731) and the connection release request signal 561 is received from the release request node 551 of FIG. 5B (732). Next, it is determined whether the connection release response signal is transmitted by the caller 511 of FIG. 5A or the called 516 (733). As the determination result, when the connection release response signal is transmitted by the caller 511, a process proceeds to step 734 and when the connection release response signal is transmitted by the called 516, a process proceeds to step 735.

At step 734, when the connection release request signal (567 of FIG. 5B) is transmitted to the access node 515 of FIG. 5A, a process proceeds to step 736 and when the connection release request signal (567 of FIG. 5B) is transmitted to the access node 512 of FIG. 5A at step 735, a process proceeds to step 736. At step 736, the relay release request signals S1, D2, and T1, . . . , the relay release request signals S1, D2, and Tn are generated and at steps 731_1, . . . , 737_{—}n, the relay release request signals S1, D2, and T1, . . . , the relay release request signals S1, D2, and Tn are all transmitted to the corresponding bridges T1, . . . , Tn.

Then, the relay release response signals wait from the bridges T1, . . . , Tn (738). Next, it is tested whether all the relay release response signals 572_1, . . . , 572_{—}n of FIG. 5A are received (739). As the test result, when all the relay release response signals are received, the connection response signal (526 of FIG. 5A) stored at step 724 of FIG. 7A is deleted (removed from a list) (741) and waits the connection release response signal (738). As a result, an operation of receiving and processing the connection release request signal 561 from the release request node 551 of FIG. 5B completes (742).

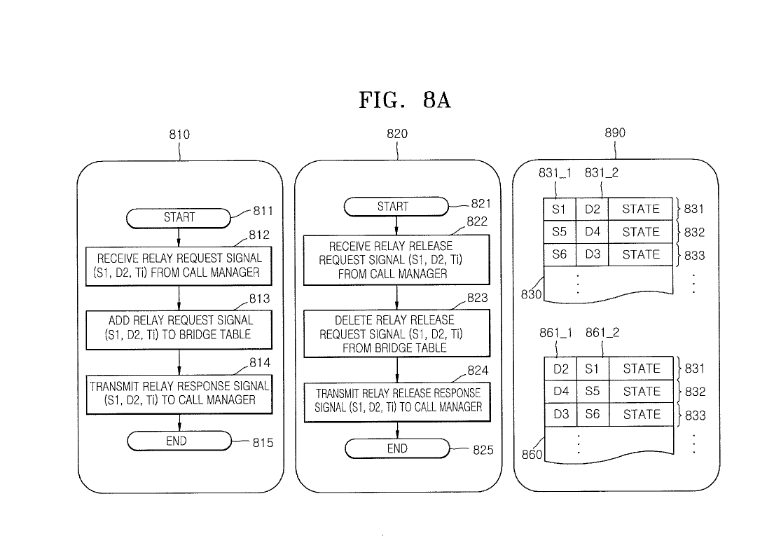

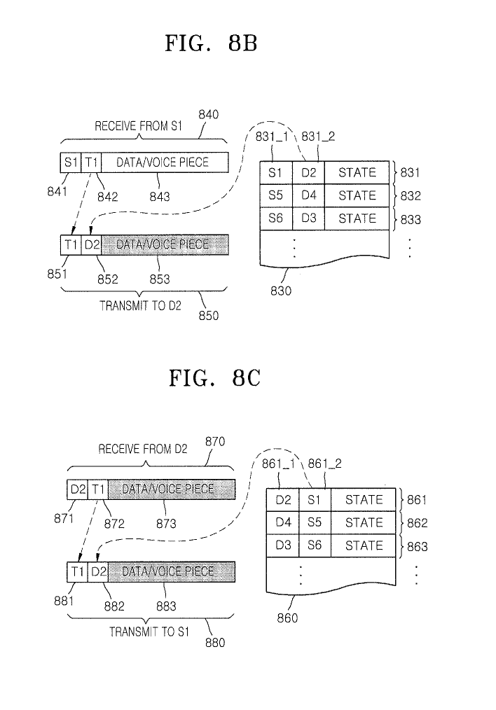

FIG. 8A is a diagram illustrating a process of allowing the bridge to establish a relay function and delete from a table in accordance with the embodiment of the present invention.

Referring to FIG. 8A, a process 810 shows a process of allowing a bridge (Ti, i=1, . . . , n) to receive and process a relay requesting signal 531_{—}i, i=n) from the call manager 513 of FIG. 5A, a process 820 shows a process of allowing a bridge (Ti, i=1, . . . , n) to receive and process the relay release request signal (571_{—}i, I=1, . . . , n) from the call manager 553 of FIG. 5B, and a process 890 shows a table generated so as to perform a relay function at the process 810 and a table deleted at the process 820.

Reviewing the process 810 in more detail, the operation of allowing the bridge (Ti, i=1, . . . , n) to receive and process the relay request signals starts (811) to receive the relay request signals S1, D2, and Ti (531_{—}i) from the call manger (513 of FIG. 5A) (812) and the bridge Ti to add table entries 831 and 861 to its own relay tables 830 and 860 (813). Then, the relay response signal (523_{—}i of FIG. 5A) is transmitted to the call manager (513 of FIG. 5A) (814) and the process 810 completes (815).

Reviewing the process 820 in more detail, an operation of allowing the bridge (Ti, i=1, . . . , n) to receive and process the relay release request signals starts (821) to receive the relay release request signals S1, D2, and Ti 571_{—}i from the call manager (553 of FIG. 5B) (822). Then, the bridge Ti deletes the table entries 831 and 861 that are present in its own relay tables 830 and 860. Then, the relay release response signal (572_{—}i of FIG. 5B) is transmitted to the call manager (553 of FIG. 5B) (824) and the process 820 completes (825).

Reviewing a process 890 in more detail, the table 830 is used when the caller 511 of FIG. 5A relays the packets transmitted to the called 516 and the table 860 is used when the called 516 of FIG. 5A relays the packets transmitted to the caller 511. The table entries 831 and 861 are used when relaying the packets between the caller 511 and the called 516 of FIG. 5A and the table entries 832, 862, 863, and 863 are used when relaying the packets between the terminals/nodes rather than the caller 511 and the called 516 of FIG. 5A, which are not displayed in the drawings (other terminals/nodes rather than the wired VoIP terminals 211c and 211d in the case of FIG. 2).

FIG. 8B is a diagram illustrating a process of allowing the bridge to relay the voice/data of the origination subscriber terminal/node in accordance with the embodiment of the present invention.

In FIG. 8B, the table 830 is the same as the table 830 of FIG. 8A. In FIG. 8B, the packet 840 shows the packet received by the bridge 514_{—}i of FIG. 5A from the caller 511 of FIG. 5A, number 841 shows the address/identification number of a caller called the caller 511, number 842 shows the address and identification number (corresponding to the bridge (Ti=514_{—}i)) of a receiver, and data 843 is a voice/data piece.

As a result, the bridge 514_{—}i searches number 831_1 in the table 830 while watching the number 841 of the packet 840 to recognize the D2 (address/identification number corresponding to the called 516 of FIG. 5A) that is number 831_2 stored as the table entry and the number 842 of the packet 840 moves to a position of the number 851 and is replaced with number 831_2 (that is, the destination is the called 516) at a position where the number 842 is present, and the data 843 generates the packet 850 that is in an original state and then is transmitted to the access node 515.

FIG. 8C is a diagram illustrating a process of allowing the bridge to relay the voice/data of the destination subscriber terminal/node in accordance with the embodiment of the present invention.

In FIG. 8C, the table 860 is the same as the table 860 of FIG. 8A. In FIG. 8C, the packet 870 shows the packet received by the bridge 514_{—}i of FIG. 5A from the called 516 of FIG. 5A, number 871 shows the address/identification number of a caller called the called 516, number 872 shows the address and identification number (corresponding to the bridge (Ti=514_{—}i)) of a receiver, and data 873 is a voice/data piece. As a result, the bridge 514_{—}i searches number 861_1 in the table 860 while watching the number 871 of the packet 870 to recognize the D2 (address/identification number corresponding to the called 516 of FIG. 5A) that is number 831_2 stored as the table entry and the number 872 of the packet 870 moves to a position of the number 871 and is replaced with number 861_2 (that is, the destination is the caller 511) at a position where the number 872 is present, and the data 880 generates the packet 873 that is in an original state and then is transmitted to the access node 512.

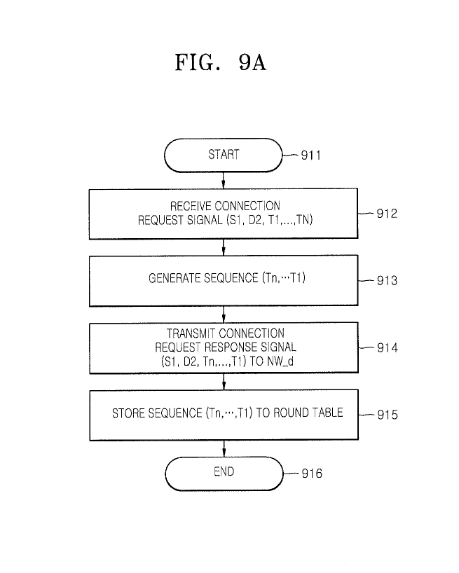

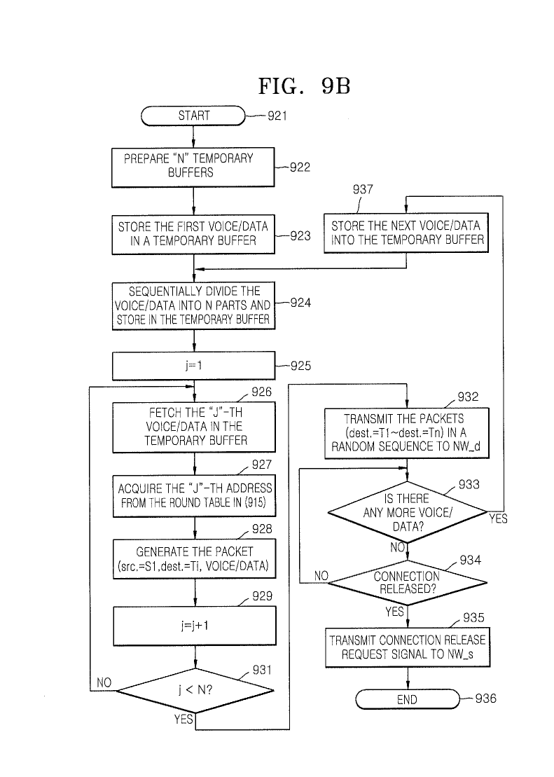

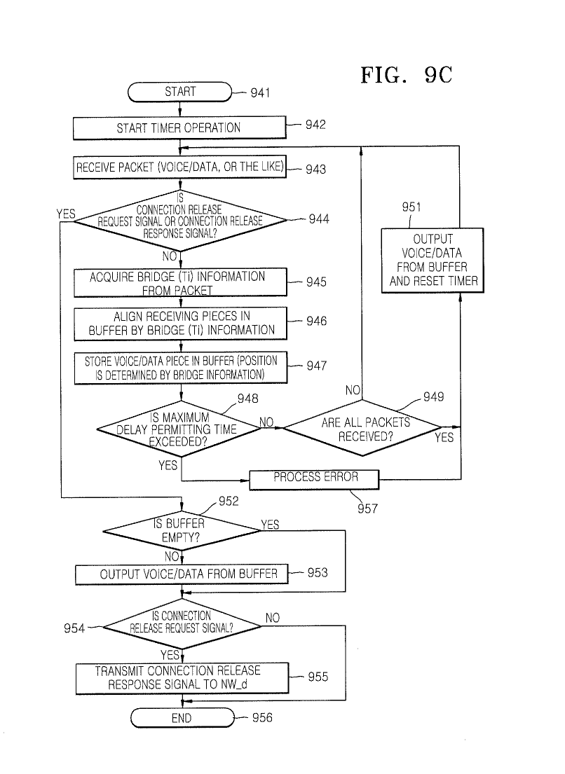

FIG. 9A is a diagram illustrating an initial operation of the origination subscriber terminal/node in accordance with the embodiment of the present invention.

Referring to FIG. 9A, a connection of the called 516 of FIG. 5A with the caller 511 of FIG. 5A starts 911. The call manger 513 of FIG. 5A receives the connection request signal transmitted through the access node 515 (912) and a sequence of the bridges T1, . . . , Tn that are in the received connection request signal (524 of FIG. 5A) are randomly changed (herein, changed to Tn, . . . , T1) (913). Then, the connection request response signals S1, D2, Tn, . . . , T1 reflecting the changed bridge sequence (the connection response signal (525) of FIG. 5A) are generated and the generated connection request response signals are transmitted to the access node 515 (914). Next, the changed bridge information is stored in the round table in a sequence previously promised with the origination subscriber terminal/node (915). As a result, the connection with the caller 511 of FIG. 5A completes (916). Herein, step 915 includes a maximum delay permitting time of a circulating cycle. In this case, the maximum delay permitting time of the circulation cycle refers to the whole permission time in which n packets are received when the number of bridges is n.

In addition, the sequence previously promised with the above-mentioned origination subscriber terminal/node means a sequence previously promised with an opponent about whether to use the bridge sequence to be used when the voice/data pieces are transmitted and received to and from the opponent subscriber terminals/nodes without changing the sequence of the bridge address/identification number information included in the connection response signal (525 of FIG. 5A) or about whether to use the bridge sequence by changing the sequence by other methods.

FIG. 9B is a diagram illustrating a process of allowing the destination subscriber terminal/node to transmit the voice/data in accordance with the embodiment of the present invention.

Referring to FIG. 9B, step of transmitting the voice/data starts (921) and the temporary buffer capable of including the N voice/data pieces (N is the number of bridges determined at step 915 of FIG. 9A) (922). Then, the first voice/data information is stored in the temporary buffer at step 922 (923) and the voice/data information is sequentially divided into N pieces (924).

Then, j is set to be 1 (925), a j-th voice/data piece is fetched from a j-th temporary buffer (926), a number/address of the j-th bridge is fetched at the round table stored in step 915 of FIG. 9A (927). Next, the packet using the selected bridge as the destination is generated and stored (928) and j is set to be j+1 (929). Next, a process proceeds to step 931 if smaller than N or proceeds to step 926, if not, by testing whether j<n (N is the number of bridges at step 915) (932). At step 932, the packets (N number) stored at step 928 is transmitted in a random sequence.

Next, it is tested whether the voice/data to be transmitted is further present (933). As the test result, if it is determined that the voice/data to be transmitted is present, the next voice/data are stored in the temporary buffer (937) and a process returns to step 924. As the test result, if it is determined that there is no voice/data to be transmitted, it is determined whether the connection state is released (934). As the determination result, when the connection is not released, a process returns to a step 933 and when the connection is released, the connection release request signal is transmitted to the access node 512 of FIG. 5A (935). Therefore, the called 516 of FIG. 5A ends the transmission process to the caller 511 (936).

FIG. 9C is a diagram illustrating a process of allowing the destination subscriber terminal/node to receive the voice/data in accordance with the embodiment of the present invention.

Referring to FIG. 9C, reception starts 941 and a timer operation starts (942). Then, the packet is received (943) and it is determined whether the contents of the received packets are the voice/data pieces or the connection release request signal (564 of FIG. 5B) or the connection release response signal (568 of FIG. 5B) (944). As the determination result, if it is determined that the contents of the received packet are the voice/data pieces, the bridge Ti information is searched from the packet received at step 943 (945). Next, at step 915 of FIG. 9A, the position of the voice/data piece is searched by the bridge receiving sequence stored in the table (946) and the voice/data piece is stored in the corresponding position of the buffer (947). Next, it is tested whether the time of the timer starting the operation exceeds the maximum delay permitting time set at step 915 of FIG. 9A (948). As the test result, if it is determined that the time of the timer does not exceed the set maximum delay permitting time, it is tested whether all the packets are received by the stored table at step 915 of FIG. 9A (949). As the test result, if not, a process proceeds to an error processing step (957) and when all the packets are received, the voice/data stored in the buffer are output and the timer time is initialized (951). Then, a process returns to step 943.

The error processing step 957 is a case in which the all the voice/data pieces are not received in the buffer of the step 947 even though the maximum delay permitting time set at step 915 of FIG. 6A is exceeded. As the example, when the bridge through which the packets transmitted by the opponent passes are sequentially designated as in the bridges T3, T5, T2, T4, and T1, for any reason, only the bridges T3, T5, T2, and T1 are received and the bridge T4 is lost. In this case, a missed portion is displayed. Then, a process proceeds to step 951.

When the determination result is yes at step 944, it is tested whether the receiving buffer is empty (952). If it is determined that the buffer is not empty, a process proceeds to the step 953 and if it is determined that the buffer is empty, a process proceeds to step 954. At step 953, all the voice/data pieces that are present in the buffer are output and at step 954, when the contents of the received packets are the connection release request signal (564 of FIG. 5B), a process proceeds to step 955 or proceeds to step 956. At step 955, the connection release response signal (565 of FIG. 5B) is transmitted to the access node 515 and at step 956, the receiving operation of the called 516 of FIG. 5A ends.

In the network to which the method of the present invention is applied, there may be a case of sniffing the transmitting/receiving packets by directly connecting with the wired subscriber in parallel as in the terminal 381 of FIG. 3, listening in the specific path in the network as in the terminal 382, or wiretapping the communication contents of the wireless subscriber or performing the relay function as in the terminal 482 of FIG. 4. In the case of the terminal 381 of FIG. 3, the destination of the packets transmitted by the wired node 311c is the bridges 341 and 342 in the network rather than the wired node 311d. Although FIG. 3 shows two bridges for convenience, all the voice/data are divided into pieces or transmitted or received when a larger number of bridges are present. The wired node 311d that is the final destination is not displayed, such that the final destination cannot be searched and the sequence of again assembling the pieced voice/data cannot be searched. In addition, the case of the terminal 382 of FIG. 3 is more serious case than the case of the terminal 381. That is, when the voice/data pieces passing through the bridge 341 are transmitted to the access node 321d via the intermediate node 264, the terminal 382 is in a state of sniffing only a portion of the divided voice/data. Further, even in the case of the terminal 481 of FIG. 4, even though the wireless node 411b sniffs all the voice/data pieces transmitted to the wireless node 411a, the destination of the packets including the voice/data pieces transmitted by the wireless node 411b is the bridge 441 or the bridge 442 in the network and the wireless node 411a that is the final destination cannot be searched and the sender of the packet including the voice/data pieces received by the wireless node 411b is the bridge 441 or the bridge 442 in the network and the wireless node 411a that is a first sender cannot be searched and the sequence of again assembling cannot also be searched.

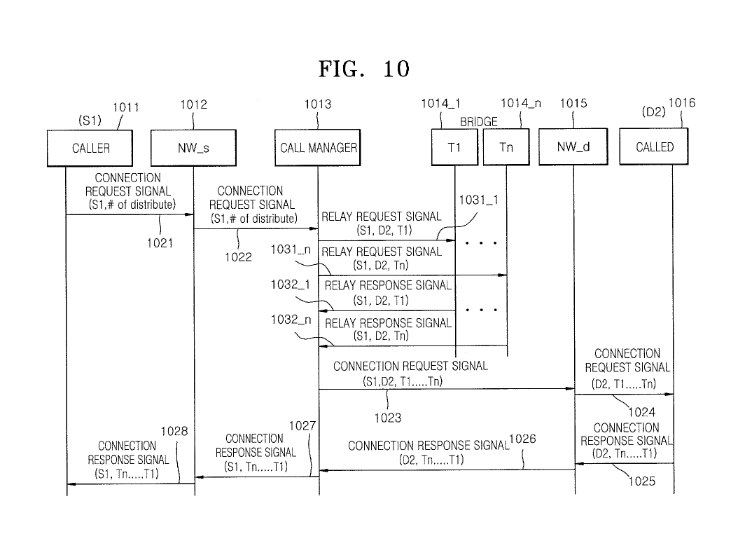

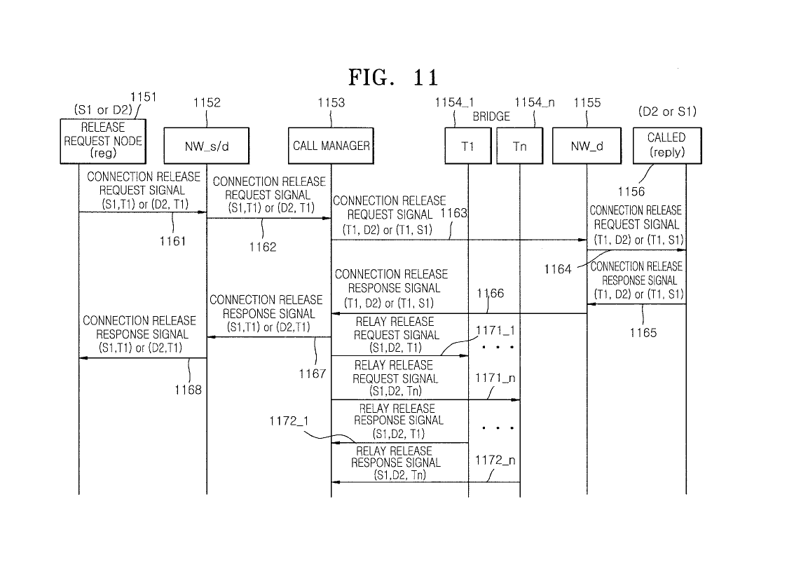

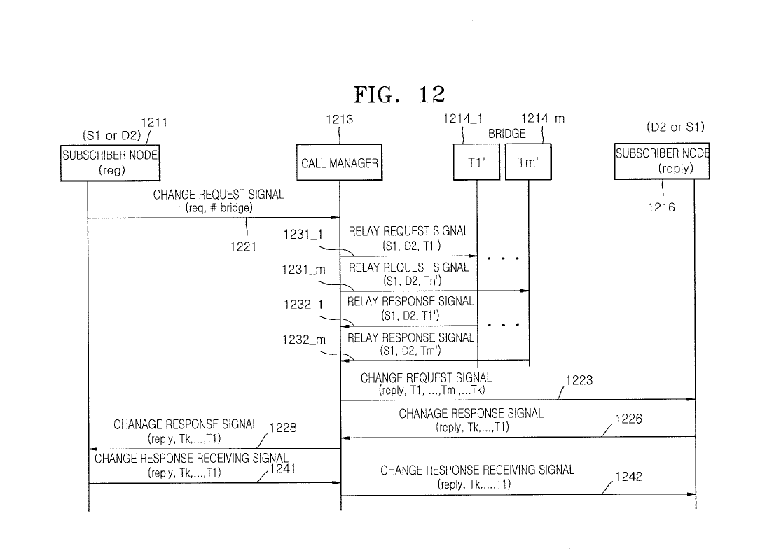

As another example in which the above-mentioned method is modified and applied, when the origination subscriber terminal/node and the destination subscriber terminal/node are connected to each other, there may be a method of promising the number of bridges to be previously used and connecting the opponent address/identification number corresponding to the number previously registered in the call manager 513 (553 of FIG. 5B). In this case, a process of connecting the origination subscriber terminal/node with the destination node/terminal may be the same as FIG. 10 and a process of connection release may be performed as in FIG. 11.

FIG. 10 is a diagram illustrating a process of transmitting and receiving access request signal/access request response signal without revealing address/identification number of an opponent when the path is established as shown in FIG. 5A in accordance with the embodiment of the present invention.

In FIG. 10, when a call manager 1013 (corresponding to the call manager 513 of FIG. 5A) transmits a connection request signal 1024 to a called 1016 (corresponding to the called 516 of FIG. 5A), the first origination node/terminal 1011 information is not searched. However, although the called 1016 knows that the caller 1011 (corresponding to the caller 511 of FIG. 5A) request the connection by the previous promise, a connection request response signal 1025 does not also include the address/identification number of the caller 1011. In addition, the call manager 1013 receiving the connection request response signal 1025 deletes the address/identification number of the called 1016 transmitting the connection request response signal to the connection request response signal 1028 transmitted to the caller 1011 and replaces the connection request response signal with the information of the caller 1011 and transmits the information of the caller 1011.

FIG. 11 is a diagram illustrating a process of transmitting and receiving messages without revealing the address/identification number of the opponent when the path is established as shown in FIG. 5B in accordance with the embodiment of the present invention.

The case in FIG. 11 is a processing process of the connection release request. When a release request node 1151 (corresponding to 551 of FIG. 5B) transmits the connection release request 1161 (corresponding to 561 of FIG. 5B), the address/identification number of the called 1156 is not allocated, only the address/identification number of bridges 1154_1, . . . , 1154_{—}n are transmitted, and only the bridge information is transmitted to the connection release response signal without including the address/identification number of the release request node 1151 (corresponding to 551 of FIG. 5B). The call manager 1153 receiving the connection release response signal transmits only the address/identification information having a form in which the connection release operation with the bridge in the network is the same as FIG. 5B but the connection release response signal transmitted to the release request node 1151 is the same as the connection release request signal 1161. The bridge used during the connection request and the connection release uses only one of the used bridge address/identification number for convenience. In this case, even though all the signal processing operations (the connection request/response process, the connection release request/response process) are sniffed, since there is no information on the final opponent, who is communicating cannot be known if the information stored in the call manager 1153 is not known.

As another example in which the above-mentioned method is modified and applied, there may also be a method of previously registering the number of bridges and the address/identification number of the destination subscriber terminal/node corresponding to the number in the call manager 513 of FIG. 5A (the call manager 553 of FIG. 5B) and connecting them. In this case, even though the origination node/terminal does not know somebody until the connection of the destination subscriber terminal/node completes, there may be a method of confirming who the origination node/terminal is by the voice/data information transmitted between the destination subscriber terminal/node after the connection completes once. The method is the same as a principle that the destination subscriber does not know who the opponent is until the call processing between the origination subscriber and the destination subscriber completes in the existing mechanical exchanger but the call-processing completes and then, the destination subscriber knows who the opponent is during the communication.

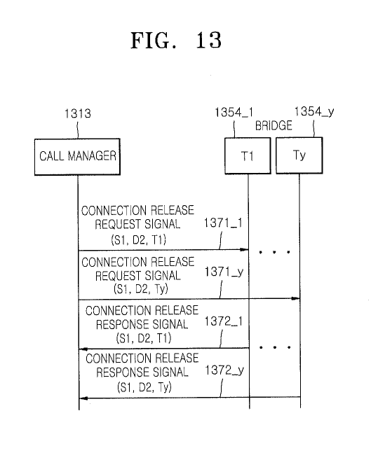

In the state in which the origination subscriber terminal/node and the destination subscriber terminal/node are connected to each other by the above-mentioned method, the number of bridges is changed as necessary during the transmission and reception of the voice/data information or the origination subscriber terminal/node or the destination subscriber terminal/node request the bridge change to the opponent through the call manager when wanting the path change to perform the change. The method may randomly change the plurality of paths established while the origination subscriber terminal/node and the destination subscriber terminal/node transmits and receives information, thereby more lowering the risk of leakage of the information. The detailed example of the above-mentioned method is the same as FIGS. 12 and 13.

FIG. 12 is a diagram illustrating a process of changing the number of bridges or paths according to the need during the transmission of information by connecting an origination subscriber terminal/node with a destination subscriber terminal/node in accordance with the embodiment of the present invention.

FIG. 13 is a diagram illustrating a process of releasing a relay of the bridge not used during the process of changing the number of bridges and the paths as illustrated in FIG. 12 in accordance with the embodiment of the present invention.

In FIG. 12, a subscriber node 1211, which is the origination or destination subscriber terminal/node, is the same as the caller 1011 of FIG. 10. A call manager 1213 of FIG. 12 and a call manager 1313 of FIG. 13 are the same as the call manager 1013 of FIG. 10 and bridges 1214_1, . . . , 1214_{—}m of FIG. 12 and bridges 1354_1, . . . , 1354_{—}y of FIG. 13 are managed by the call manager (the call manager 513 of FIG. 5A, the call manager 553 of FIG. 5B, or the call manager 1013 of FIG. 10). The subscriber node 1216 of FIG. 12, which is the opponent subscriber terminal/node, is the same as the called 1016 of FIG. 10. In addition, the bridges 1214_1, . . . , 1214_{—}m of FIG. 12 is bridges newly selected by the call manager 1213 by the request of the subscriber node 1211.

When the subscriber node 1211 of FIG. 12 changes the number of bridges or wants the path change as necessary, if the bridge change request signal 1221 is transmitted to the call manager 1213, the call manger 1213 selects k bridges (1291_1, . . . , 1291_{—}k) among the bridges managed by the call manager 1213 if it is determined that the subscriber node 1211 is a legal terminal/node and the number of bridges is within the permitted range (where the subscriber node 1211 is set to be k) and then, compares the selected bridges with the bridges in the connection response signal (526 of FIG. 5A) stored therein to select only the bridges (where 1214_1, . . . , 1214_{—}m; m k) that are not present in the connection response signal among the selected bridges to transmit the relay request signal 1231_1 (configured by S1, D2, and T1), . . . , the relay request signal 1231_{—}m (configured by S1, D2, and Tm'), respectively. Actually, although the access node/base stations 1012 and 1015 of FIG. 10 are present between the subscriber node 1211 and the call manager 1213 and between the call manger 1213 and the subscriber node 1216 as shown in FIG. 10, the access node/base stations 1012 and 1015 simply performs the relay function and therefore, the description thereof will be omitted. The bridges 1214_1, . . . , 1214_{—}m receiving the relay request signals transmit a relay response signal 1232_1 (configured by S1, D2, and T1′), . . . , a relay response signal 1232_{—}m (configured by S1, D2, and Tm'), respectively, to the call manager 1213. When the call manager 1213 receives all the relay response signals 1231_1, . . . , 1231_{—}m, the call manager 1213 generates a change request signal 1223 (configured by S1, D2, T1, . . . , Tk) and transmits the generated change request signal 1223 to the subscriber node 1216. In this case, T1, . . . , Tk are the addresses/identification numbers of the selected bridges 1291_1, . . . , 1291_{—}k. The subscriber node 1216 receiving the change request signal 1223 randomly arranges the bridge sequence to generate the change response signal 1226 (S1, D2, Tk, . . . , T1′) and transmit the generated change response signal to the call manger 1213. If the call manager 1213 temporarily stores the change response signal 1226 to transmit the same change response signal 1226 as the change response signal 1226 to the subscriber node 1211 and the subscriber node 1211 transmits the change response receiving signal 1241 informing that the information transmission/reception by the change response signal 1228 is ready, the call manager 1213 transmits the same change response receiving signal 1242 as the change response receiving signal 1241 to the subscriber node 1216. The change response receiving signal means that the changed bridges may be used when the information is transmitted to the subscribed node 1216 and the subscriber node 1211. In addition, in FIG. 13, the call manager 1313 is the same as the call manager 1213 of FIG. 12 and compares the connection response signal (526 of FIG. 5A) with the change response signal 1226 that are stored therein immediately after the change response signal is transmitted to the subscriber node 1211 to select (assumed to be T1, . . . , Ty) the bridges that are not present in the change response signal 1226, thereby generating a relay release request signal 1371_1 (configured by S1, D2, and T1), . . . , a relay release request signal 1371_{—}y (configured by S1, D2, and Ty). Then, the call manager 1313 transmits the generated relay release request signals to the bridges 1354_1, . . . , 1354_{—}y that performs the relay function between the subscriber node 1211 and the subscriber node 1216, such that the bridges 1354_1, . . . , 1354_{—}y transmits the relay release response signal 1372_1 (configured by S1, D2, and T1), . . . , the relay release response signal 1372_{—}y (configured by S1, D2, and Ty) to the call manger 1313. The call manger 1313 receiving all the relay release response signals 1372_1, . . . , 1372_{—}y replaces the bridge information of the connection response signal (526 of FIG. 5A) that is stored therein with the bridge information that is present in the change response signal 1226 of FIG. 12.

Meanwhile, as the method for changing the number of bridges or the transmission sequence in the state in which the origination subscriber terminal/node with the destination subscriber terminal/node are connected to each other, there may be a method of allowing one of the origination and the destination subscriber to directly transmitting the change request signal to the opponent to receive the change response signal. However, the method may expose the address/identification number of the opponent to the change request signal or the change response signal.

Further, in FIG. 5A, when one (the caller 511 or the called 516) of the subscriber terminal/node is the general terminal/node that does not include the function as described above, the access node 512 or the access node 515 includes a proxy function instead of the function of the caller 511 or the called 516, such that the voice/data may be more safely transmitted between the node/terminal having the function of the caller 511 or the called 516 of FIG. 5A from the proxy.

In the above-mentioned embodiment, the call manager managing the origination and destination subscriber terminal/nodes and the plurality of bridges are provided. The origination and destination subscriber terminals/nodes transmitting the voice/data information by the IP packet may be a network system that divides the voice/data into the pieces having the previously promised size and transmits the divided pieces to the bridges.

The above-mentioned subscriber terminal/node may be the wired or wireless origination subscriber terminal/node that generates and processes the connection request signal configured by the address/identification number of the origination subscriber terminal/node, the address/identification number of the destination subscriber terminal/node, and the desired number of bridges to the call manager and generates and processes the connection release request signal for the release of the previously connected state.

The above-mentioned number of bridges may be the number of bridges randomly generated by the origination subscriber terminal nodes within the bridge maximum number in which the call manager of claim 1 is permitted to the origination subscriber terminal/node.

The above-mentioned destination subscriber terminal/node may be the wired or wireless destination subscriber terminal/node that receives and processes the connection request signal configured by the address/identification number of the origination subscriber terminal/node, the address/identification number of the destination subscriber terminal/node, and the plurality of bridges from the call manager and generates and processes the connection release request signal for the release of the previously connected state.

The above-mentioned bridge address/identification number, which is the address/identification number of the bridge transmitted to the origination and destination subscriber terminal/node by the call manager, means the bridge address/identification number having the same system as the address/identification number used by the origination and destination subscriber terminal/node.

The above-mentioned call manager may allow the origination and destination subscribers to include and manage the maximum number information of available bridges, process the connection request signal transmitted by the origination subscriber terminal/node, and process the connection release request signal transmitted by the origination and destination subscribers.

The above-mentioned bridge may be implemented by some modules of the existing router in the network or may be implemented by an independent device and may use the same address/identification number system as the origination and destination subscriber terminal/node and may have a function or relaying or releasing the relay of the voice/data packets of the origination and destination subscriber terminals/nodes by the request of the call manager.

In the above description, dividing the voice/data into the pieces of the previously promised size may mean dividing the voice/data information into the plurality of pieces of the permitted IP packet length or less at the time of transmitting the IP packet by the origination subscriber terminal/node 511 or the destination subscriber terminal/node 516, wherein the previously promised size is previously determined by the destination subscribers and the origination subscribers or may be the pieces having the previously defined size between the call manager and the origination/destination subscribers.

Referring to FIG. 5A, in accordance with the embodiment, the process of establishing the plurality of paths so as for the origination subscriber terminal/node 511 to divide the voice/data into pieces and transmit the divided voice/data to the origination subscriber terminal/node 516 may be a network path establishing method including: the origination subscriber terminal/node 511 generating the connection request signal 521 configured by his/her own address/identification number, the opponent address/identification number, and the number of request bridges; the origination subscriber terminal/node 511 transmitting the generated connection request signal 521 to the call manager 513; the call manager 513 receiving the connection request signal 522 testing the legality (the number of terminals/nodes and bridges) of origination subscriber terminal/node 511 to reject the connection of the illegal terminals/nodes (or no response) and select the bridges 514_1, . . . , 514_{—}n corresponding the number of bridges of the connection request signal 522 among the bridges managed thereby and generate the relay request signals 531_1, . . . , 531_{—}n to be transmitted to each bridge 514_1, . . . , 514_{—}n, if it is determined that the terminal/node is legal; the call manager 513 transmitting the relay request signals 531_1, . . . , 531_{—}n to each of the selected bridges 514_1, . . . , 514_{—}n; each of the bridges 514_1, . . . , 514_{—}n receiving the relay request signals 531_1, . . . , 531_{—}n of the call manager 513 forming the relay response signals 532_1, . . . , 532_{—}n and transmitting the formed relay response signals to the call manager 513; after receiving all the relay response signals 532_1, . . . , 532_{—}n, the call manager 513 generating the address/identification number of the origination terminal node 511, the address/identification number of the destination subscriber terminal/node 516, and the address/identification number of the bridge 514_1 transmitting the relay response signal 532_1, . . . , the address/identification number of the bridge 514_{—}n transmitting the relay response signal 532_{—}n (where n is the number of bridges); the call manager 513 transmitting the generated connection request signal 523 to the terminal/node 516 of the destination subscriber terminal/node 516; the destination subscriber terminal/node 516 receiving the connection request signal 524 from the call manger 513 randomly arranging the sequence of the bridges 514_1, . . . , 514_{—}n present in the relay request signals 531_1, . . . , 531_{—}n to generate the connection response signal 525 like the address/identification number of the origination terminal node 511, the address/identification number of the destination subscriber terminal/node 516, and the address/identification number of the bridge 514_1 transmitting the relay response signal 532_1, . . . , the address/identification number of the bridge 514_{—}n transmitting the relay response signal 532_{—}n; the destination subscriber terminal/node 516 transmitting the generated connection response signal 525 to the call manager 513; and the call manger 513 receiving the connection response signal 526 transmitting the connection response signal 527 to the origination subscriber terminal/node 511.

Referring to FIG. 5B, a method for releasing a network path in accordance with the embodiment includes: the origination subscriber terminal/node or the destination subscriber terminal/node (hereinafter, referred to as the subscriber terminal/node) of which the connection will be released generating the connection release request signal 561; the subscriber terminal/node transmitting the connection release request signal 561 to the call manager 553; the call manager 553 receiving the connection release request signal 562 testing the legality (terminals/nodes) of the subscriber terminal/node transmitting the connection release request signal 562 to reject the connection release of the illegal terminals/nodes (or no response) and transmit the connection release request signal 563 to the opponent terminal/node 556, if it is determined that the terminal/node is legal; the terminal/node 556 receiving the connection release request signal 564 generating the connection release response signal 565; the terminal/node 556 transmitting the connection release response signal 565 to the call manager 553; the call manager 553 receiving the connection release response signal 566 transmitting the connection release response signal 567 to the terminal/node 551; the call manager 553 generating the corresponding relay release request signals 571_1, . . . , 571_{—}n to each of the bridges 554_1, . . . , 554_{—}n that provide the plurality of paths between the origination subscriber terminal/node 551 and the destination subscriber terminal/node 556; the call manager 553 transmitting the generated relay release request signals 571_1, . . . , 571_{—}n to each of the bridges 554_1, . . . , 554_{—}n; and each of the bridges 554_1, . . . , 554_{—}n receiving the relay release request signals 571_1, . . . , 571_{—}n transmitting the relay release response signals 572_1, . . . , 572_{—}n to the call manager 553.

In addition, the initial operation of the origination subscriber terminal/node 551 will be described with reference to FIGS. 5A and 5B. The operation may include: setting the number of paths between the destination subscriber terminal/node 556 to be the number (n, n≦N) within the range of numbers N permitted by the call manger 553; generating the connection request signal 521 configured by the address/identification number of the origination subscriber terminal/node 551, the address/identification of the destination subscriber terminal/node 556, and the number n of set bridges; transmitting the connection request signal 521 to the call manger 553; waiting the connection response signal 525 for the connection request signal 521; receiving the connection response signal 525 (configured by the address/identification number of the origination subscriber terminal/node 551, the address/identification bridge 554_1 of the destination subscriber terminal/node 556, . . . , the address/identification number of the bridge 554_{—}n); and extracting the information of the address/identification number of the bridge 554_{—}n, . . . , the address/identification number of the bridge 554_1 from the connection response signal 525 and storing the extracted information in the round table in a sequence previously promised with the destination subscriber terminal/node 556.

The initial operation of the destination subscriber terminal/node 556 will be described with reference to FIGS. 5A and 5B. The operation may include: receiving the connection request signal 523 from the call manager 553; extracting the information of the address/identification number of the bridges included in the connection request signal 523 to recognize that the number of bridges is n and randomly arrange the sequence of the bridges (Ti, i=1, . . . , n) (for example, arrangement like “bridge Tn, . . . , bridge T1), configuring the connection response signal 525 (for example: configured by the address/identification number of the origination subscriber terminal/node 551, the address/identification number of the destination subscriber terminal/node 556, the address/identification of the bridge Tn, . . . , the address/identification of the bridge T1) based on the sequence information of the arranged bridge Ti; transmitting the configured connection response signal 525 to the call manager 553; and storing the bridge information included in the connection response signal 525 in the round table in a sequence previously promised with the origination subscriber terminal/node 551.

The method for transmitting the voice/data from the origination subscriber terminal/node or the destination subscriber terminal/node to the opponent subscriber terminal/node may include: preparing a temporary buffer in which the number of pieces having the predetermined size is the size of the determined numbers n; storing the voice/data information to be transmitted in the temporary buffer; sequentially fetching the voice/data information stored in the temporary buffer as the pieces having the predetermined size; sequentially fetching the information of the bridge address/identification number from the stored round table; generating and storing packets in which the origination is configured by the address/identification number thereof, the destination is configured by the bridge address/identification number sequentially fetched, and the information to be transmitted is configured by the voice/data pieces; transmitting the stored n packets in a random sequence; testing whether the voice/data information to be transmitted remain; if it is determined that the voice/data information remains, sequentially storing the remaining voice/data information in the temporary buffer and then, returning to the sequentially fetching into the pieces of the previously promised size, determining whether the connection is released if it is determined that the voice/data information does not remain; testing whether the voice/data to be transmitted again remain when the connection release is not performed, generating the connection release request signal when the connection is released and transmitting the generated connection release request signal to the call manager, and ending the transmission of the voice/data to the opponent subscriber terminal/node.

The process of allowing the origination subscriber terminal/node or the destination subscriber terminal/node to receive the voice/data from the opponent subscriber terminal/node may include: setting the receiving timer (setting an initial value to be 0 increasing over time, and setting the maximum delay permitting time) so as to be set to be the time when all the packets transmitted by the bridges having the determined numbers n can be received once and preparing the receiving buffer configured by a piece xn having the predetermined size (S1); proceeding to 511 if the connection release request signal 561 is received from the call manager 553 and if not, proceeding to S3 (S2); receiving from the opponent subscriber terminal/node the packets in which the origination is configured by the address/identification number thereof, the destination is configured by the bridge address/identification number sequentially fetched, and the information to be transmitted is configured by the voice/data pieces (S3); recognizing the bridge address/identification number from the received packets (S4); storing the received voice/data pieces in a position of an i-th piece of the receiving buffer by recognizing the recognized bridge address/identification number as an i-th bridge address/identification number in the round table (S5); testing whether the set timer exceeds the maximum delay permitting time to proceed to S10 if it is determined that the set timer exceeds the maximum delay permitting time and proceed to S7, if not (S6); determining whether all the packets transmitted by all the bridges stored in the round table are received (S7); proceeding to S2 if it is determined that all the packets are not received and proceeding to S9, if not (S8); outputting the voice/data information included in the receiving buffer contents, setting the state of the receiving buffer to be empty, filling the contents thereof will null, and setting the initial value of the timer to be 0 and then, proceeding to S2 (S9); displaying the receiving error at the position at which the receiving buffer is filled with null (S10); determining whether the state of the receiving buffer is empty to proceed to S13 if it is determined that the state of the receiving buffer is empty and proceeding to S12, if not (S11); outputting the voice/data included in the contents of the receiving buffer and proceeding to S13; and generating the connection release response signal configured by its own address/identification number, the opponent address/identification number, or the like, and transmitting the generated connection release response signal to the call manager, and ending the reception of the voice/data from the opponent subscriber terminal/node (S13).

Referring to FIGS. 5A and 5B, the process of establishing the bridges by allowing the call manager 553 to receive the connection request signal 521 from the origination subscriber terminal/node 551 may include: receiving the connection request signal 521 configured by the address/identification number of the origination subscriber terminal/node 551 (for example: S1) from the origination subscriber terminal/node 551, the address/identification number of the destination subscriber terminal/node 516 (for example: D2), and the number n of bridges to be requested; testing the legality of the connection request signal 521 to perform no response if it is determined that the connection request signal 521 is not legal and selecting proper bridges at the position at which the paths are different, if so; generating each of the bridge relay request signals 531_1, . . . , 531_{—}n corresponding to the selected bridges [(for example, S1, D2, and T1), . . . , (S1, D2, and Tn)]; transmitting the corresponding relay request signals 531_1, . . . , 531_{—}n, respectively; waiting the relay response signals 532_1, . . . , 532_{—}n from each bridge; testing whether the relay response signals 532_1, . . . , 532_{—}n are received from all the bridges to generate the connection request signal 523 (configured by S1, D2, T1, . . . , Tn) to be transmitted to the destination subscriber if it is determined that the relay response signals 532_1, . . . , 532_{—}n are received from all the bridges; storing the generated connection request signal 523 and then, transmitting the connection request signal 523 to the destination subscriber terminal/node and then, waiting the connection response signal (for example: configured by 51, D2, Tn, . . . , T1); when receiving the connection response signal 525 from the destination subscriber terminal/node, transmitting the received connection response signal to the origination subscriber terminal/node 551.

The process of establishing and releasing the bridges by allowing the call manager 553 to receive the connection release request signal from the origination subscriber terminal/node 551 or the destination subscriber terminal/node 556 may include: testing legality by receiving the connection release request signal to disregard the connection release request signal if it is determined that the connection release request signal is not legal; determining who the terminal/node transmitting the received connection release request signal is if it is determined that the connection release request signal is legal to transmit the connection release request signal to the destination subscriber terminal/node 556 in the case of the origination subscriber terminal/node 551 and transmitting the connection release request signal to the origination subscriber terminal/node 551 in the case of the destination subscriber terminal/node 556; generating each of the corresponding bridge relay release request signals 571_1, . . . , 571_{—}n to each of the bridges 554_1, . . . , 554_{—}n; waiting the relay release response signals 572_1, . . . 572_{—}n from each of the bridges 554_1, . . . , 554_{—}n; and testing whether the relay release response signals 572_1, . . . , 572_{—}n are received from all the bridges 554_1, . . . , 554_{—}n, removing the stored connection request signal 523 if it is determined that the relay release response signals 572_1, . . . , 572_{—}n are received from all the bridges 554_1, . . . , 554_{—}n and then, perform ending.

Referring to FIG. 5A, the process of establishing and releasing the relay function by the bridges and the process of adding and deleting to and from the relay table will be described below. The relay table includes an origination subscriber relay table and a destination subscriber relay table. An entry configuration of the origination subscriber relay table includes the address/identification number of the origination subscriber terminal/node 511 (S1), the address/identification number of the destination subscriber terminal/node 516 (D2), and the status information and an entry configuration of the destination subscriber relay table includes the address/identification number of the destination subscriber terminal/node 516 (D2), the address/identification number of the origination subscriber terminal/node 511 (S1), and the status information. The process of setting the relay function may include receiving the relay request signals 531_1, . . . , 531_{—}n configured by the address/identification number of the origination subscriber terminal/node 511 (S1), the address/identification number of the destination subscriber terminal/node 516 (D2), and the address/identification number of the bridge Ti from the call manager; adding the entry configured by (S1, D2, and status information) to the origination subscriber relay table of its own relay table and adding the entry configured by (D2, S1, and status information) to the destination subscriber relay table, by the received relay request signals 531_1, . . . , 531_{—}n; transmitting the relay response signals 532_1, . . . , 532_{—}n to the call manager 513.

Referring to FIG. 5B, the process of releasing the relay function may include receiving the relay release request signals 571_1, . . . , 571_{—}n configured by the address/identification number of the origination subscriber terminal/node 551 (51), the address/identification number of the destination subscriber terminal/node 556 (D2), and the address/identification number of the bridge Ti from the call manager 553; deleting the entry configured by (S1, D2, and status information) included in the origination subscriber relay table of its own relay table and deleting the entry configured by (D2, S1, and status information) included in the destination subscriber relay table, by the received relay release request signals 571_1, . . . , 571_{—}n; transmitting the relay release response signals 572_1, . . . , 572_{—}n to the call manager 553.

The process of relaying the voice/data of the origination subscriber terminal/node (caller party) or the destination subscriber terminal/node (called party) may include: receiving the packets from the origination subscriber terminal/node or the destination subscriber terminal/node (S101); determining whether the terminal/node transmitting the packets is the origination subscriber terminal/node or the destination subscriber terminal/node while seeing the origination address/identification number to proceed to S103 if it is determined that the terminal/node transmitting the packets is the origination subscriber terminal/node and proceed to S104 if it is determined that the terminal/node transmitting the packets is the destination subscriber terminal/node (easily determining by comparing the origination address information with the first information of the entries of each of the origination subscriber relay table and the destination subscriber relay table); replacing the address/identification number of the origination subscriber of the received packet with its own address/identification number and replacing the address/identification number information of the origination subscriber of the received packet with the address/identification number information of the destination subscriber in the entry of the origination subscriber relay table and transmitting the replaced information (S103); and replacing the address/identification number of the origination subscriber of the received packet with its own address/identification number and replacing the address/identification number information of the origination subscriber of the received packet with the address/identification number information of the destination subscriber in the entry of the destination subscriber relay table and transmitting the replaced information (S104).

Referring to FIG. 10, the process of establishing the plurality of paths so as for the origination subscriber terminal/node 1011 to divide the voice/data into pieces and transmit the divided voice/data to and from the destination subscriber terminal/node 1016 so as not to actually expose the opponent address/identification number to the connection request signal/connection request response signal and the connection release request signal/connection release response signal when the address/identification number of the destination subscriber corresponding to the number n of bridges are previously registered in the call manager 1013 by the origination subscriber may include: the origination subscriber terminal/node 1011 generating the connection request signal 1021 configured by its own address/identification number and the number of request bridges; the origination subscriber terminal/node 1011 transmitting the generated connection request signal 1021 to the call manager 1013; the call manager 1013 receiving the connection request signal 1022 testing the legality (the number of terminals/nodes and bridges) of origination subscriber terminal/node 1011 to reject the connection of the illegal terminals/nodes (or no response) and fetch the address/identification number of the destination subscriber 1016 corresponding to the number of bridges from the information registered by the origination subscriber node/terminal 1011 if it is determined that the origination subscriber terminal/node 1011 is legal and select the bridges 1014_1, . . . , 1014_{—}n corresponding the number of bridges among the bridges managed thereby and generate the relay request signals 1031_1, . . . , 531_{—}n to be transmitted to each bridge 1014_1, . . . , 1014_{—}n; the call manager 1013 transmitting the relay request signals 1031_1, . . . , 1031_{—}n to each of the selected bridges 1014_1, . . . , 1014_{—}n; each of the selected bridges 1014_1, . . . , 1014_{—}n forming the relay response signals 1032_1, . . . , 1032_{—}n by receiving the relay request signals 1031_1, . . . , 1031_{—}n of the call manager 1013 to the formed relay response signals 1032_1, . . . , 1032_{—}n to the call manager 1013; the call manager 1013 receiving the relay request signals 1031_1, . . . , 1031_{—}n from each of the bridges 1014_1, . . . , 1014_{—}n transmitting the relay request signals 1031_1, . . . , 1031_{—}n selected thereby; proceeding to next step if it is determined that all the relay response signals 1032_1, . . . , 1032_{—}n are received from each of the selected bridges 1014_1, . . . , 1014_{—}n and waiting, if not; after all the relay response signals 1032_1, . . . , 1032_{—}n are received, the call manager 1013 generating the connection request signal 1023 configured by the address/identification number of the destination subscriber terminal/node and the address/identification number of the bridge 1014_1, . . . , the address/identification number of the bridge 1014_{—}n (where n is the number of bridges of the above 1)]; the call manager 1013 transmitting the generated connection request signal 1023 to the terminal/node 1016 of the destination subscriber; the terminal/node 1016 of the destination subscriber receiving the connection request signal 1024 from the call manager 1013 randomly arranging the sequence of the bridges 1014_1, . . . , 1014_{—}n included in the relay request signals 1031_1, . . . , 1031_{—}n to generate the connection response signal 1025 like the address/identification number of the destination subscriber terminal/node 1016 and the address/identification number of the bridge Tn, . . . , the address/identification number of the bridge T1; and the terminal/node 1016 of the destination subscriber transmitting the generated connection response signal 1025 to the call manager 1013; the call manager 1013 receiving the connection response signal 1026 generating the connection response signal 1027 like the address/identification number of the origination subscriber terminal/node 1011 and the address/identification number of the bridge Tn, . . . , the address/identification number of the bridge T1 instead of the address/identification number of the destination subscriber terminal/node 1016 included in the connection response signal 1026; and the call manager 1013 transmitting the connection response signal 1027 to the origination subscriber terminal/node 1011.

Referring to FIG. 11, the process of releasing the plurality of paths between the destination subscriber terminal/node by the origination subscriber terminal/node 1011 set to divide the voice/data into pieces and transmit the divided voice/data so as not to actually expose the opponent address/identification number to the connection request signal/connection request response signal and the connection release request signal/connection release response signal when the address/identification number of the destination subscriber corresponding to the number n of bridges are previously registered in the call manager 1153 by the origination subscriber may include: the subscriber terminal/node 1151 that wants the connection release generating the connection release request signal 1161 configured by its own address/identification number and the address/identification number of any bridge Ti imparted thereto; the subscriber terminal/node 1151 transmitting the connection release request signal 1161 to the call manager 1153; the call manager 1153 receiving the connection release request signal 1162 testing the legality (terminal/node) of the subscriber terminal/node transmitting the connection release request signal 1162 to reject (or no response) the connection release of the illegal terminal/node and transmit the connection release request signal 1163 to the terminal/node 1156 by recognizing the terminal/node 1156 having the opponent address/identification number based on the subscriber terminal/node 1151 information if it is determined that the connection release is legal; the terminal/node 1156 receiving the connection release request signal 1164 generating the connection release response signal 1165, the terminal/node 1156 transmitting the connection release response signal 1165 to the call manager 1153; the call manager 1153 receiving the connection release response signal 1166 generating the connection release response signal 1166 (referred to as “bridge (Ti) connection release response signal”) configured by the address/identification number of the subscriber terminal/node 1151 as the connection release response signal to be transmitted to the terminal/node 1151 and any bridge (Ti) address/identification number imparted to the subscriber terminal/node 1151; the call manager 1153 transmitting the bridge (Ti) connection release response signal 1167 of the terminal/node 1151 to the terminal/node 1151; the call manager 1153 generating the corresponding relay release request signal 1171_1, . . . , 1171_{—}n to each bridge 1154_1, . . . , 1154_{—}n providing the plurality of paths between the destination subscriber terminal/node by the origination subscriber terminal/node; and transmitting the generated relay release request signals 1171_1, . . . , 1171_{—}n to each of the bridges 1154_1, . . . , 1154_{—}n; each bridge 1154_1, . . . , 1154_{—}n receiving the relay release request signals 1171_1, . . . , 1171_{—}n transmitting the relay release response signals 1172_1, . . . , 1172_{—}n to the call manager 1153.

Referring to FIG. 12, in the method changing the number of bridges or the change of paths if necessary in the state in which the origination subscriber terminal/node and the destination subscriber terminal/node are connected to each other, when the subscriber terminal/node 1211 requiring the number of bridges or the change of paths transmits a bridge change request signal 1221 to the call manager 1213, the call manager 1213 tests the bridge change request signal 1221 to select the bridges 1214_1, . . . , 1214_{—}m and compares the selected bridges 1214_1, . . . , 1214_{—}m with the bridges included in the connection response signal stored therein to transmit the relay request signals 1231_1, . . . , 1231_{—}m to newly selected bridges 1214_1, . . . , 1214_{—}m, generates the bridge change request signal 1233 configured by the selected bridge information after receiving all the relay response signals 1232_1, . . . , 1232_{—}m from the newly selected bridges 1214_1, . . . , 1214_{—}m to transmit the bridge change request signal 1223 to the opponent subscriber terminal/node 1216 of the subscriber terminal/node 1211 transmitting the bridge change request signal 1221, the opponent subscriber terminal/node 1216 receiving the bridge change request signal 1223 transmits the bridge change response signal 1226 to the call manager 1213, the call manager 1213 receiving the bridge change response signal 1226 transmits the bridge change response signal 1228 to the subscriber terminal/node 1211, when the subscriber terminal/node 1211 receiving the bridge change response signal 1228 transmits the change response receiving signal 1241 informing that the transmission and reception of the information is ready through the changed bridges 1214_1, . . . , 1214_{—}m to the call manager 1213, the call manager 1213 again transmits the change response receiving signal 1242 to the subscriber terminal/node 1216 to start the transmission and reception of information by using the changed bridges 1214_1, . . . , 1214_{—}m, when selecting the bridges absent in the bridge change response signal by comparing the connection response signal stored therein with the bridges of the bridge change response signal immediately after the bridge change response signal 1242 transmits to the subscriber terminal/node 1216 to transmit the relay release request signals, respectively, the bridges absent in the bridge change response signal transmits the relay release response signal to the call manager 1213, and the call manger 1213 receiving all the relay release response signals from the bridges absent in the bridge change response signal replaces the bridge information of the connection response signal stored therein with the bridge information included in the bridge change response signal.

In the embodiments in accordance with FIGS. 1 to 13, in the case of the general subscriber terminal/node in which one of the origination or destination subscriber terminal/node has the functions such as the above-mentioned embodiments and the other thereof does not have the functions, the access node or the base station connected with the general subscriber terminal/node may include the case capable of establishing the “destination subscriber terminal/node proxy” “performing the function of the destination subscriber terminal/node” having the functions such as the above-mentioned embodiments.

Another embodiment of the present invention may be a network system that includes the transmitting terminal 511, the receiving terminal 516, the call manager 513 managing the data transmission between the transmitting terminal 511 and the receiving terminal 516, and the plurality of bridges 514_1, . . . , 514_{—}n transmitting data pieces divided into the promised number by the control of the call manager 513.

The bridges 514_1, . . . , 514_{—}n may use the same identifier system as the transmitting terminal 511 and the receiving terminal 516 and perform the relay or the relay release of each of the divided data pieces.

The call manger 513 manages the maximum number of bridges, processes the connection request signals 521 and 522 transmitted by the transmitting terminal 511, processes the connection release request signals 561 and 562 transmitting by the transmitting terminal 511 and the receiving terminal 516, and informs the maximum number of bridges so as to allow the transmitting terminal 511 to randomly generate the number of bridges.

The connection request signals 521 and 522 may be the signal 521 immediately transmitted by the transmitting terminal 511 and the access node 512 may be the connection request signal 522 by receiving and retransmitting the connection request signal 521 from the transmitting terminal 511. The connection release request signals 561 and 562 may be the signal 561 transmitted from the transmitting terminal 551 that releases the connection by the same principle and may be the connection release request signal 562 so as to allow the access node 552 to receive and retransmit the connection release request signal 561 from the transmitting terminal 551.

The transmitting terminal 511 may be a wired device and a wireless device that may generate and process the connection request signals 521 and 522 and the connection release request signals 561 and 562 including the identifier of the transmitting terminal 511, the identifier of the receiving terminal 516, and the number of bridges required by the transmitting terminal 511.

The transmitting terminal 511 may be a wired device and a wireless device that may receive and process the connection request signals 521 and 522 including the identifier of the transmitting terminal 511 and the identifier of the bridges 514_1, . . . , 514_{—}n, and generate and process the connection release request signals 561 and 562.

The meaning of the division into the promised number may mean the division of data into the predetermined size between the transmitting terminal 511 and the receiving terminal 516 or among the transmitting terminal 511, the receiving terminal, and the call manager 513.

The transmitting terminal 511 or the receiving terminal 516 may communicate with the access node 512 having the same identifier system as the bridges 514_1, . . . , 514_{—}n or the opponent through the access node 515.

Another embodiment of the present invention may be a method for establishing a data transmission path including: a first step of allowing the transmitting terminal 511 to transmit the first connection request signals 521 and 522 including the identifier of the receiving terminal 516 and the number of request bridges to the call manager 513; a second step of allowing the call manager 513 to select the plurality of bridges 514_1, . . . , 514_{—}n according to the number of request bridges and transmit the second connection request signals 523 and 523 including the identifier of the transmitting terminal and the identifiers of the plurality of selected bridges 514_1, . . . , 514_{—}n to the receiving terminal 516; a third step of allowing the receiving terminal 516 to rearrange the identifiers of the plurality of bridges 514_1, . . . , 514_{—}n included in the second connection request signals 523 and 524; and a fourth step of allowing the receiver terminal 516 to transmit the connection response signals 525 and 526 including the identification number of the transmitting terminal 511 and the identifiers of the plurality of rearranged bridges to the transmitting terminal 511. In this case, the second connection request signals 523 and 524 may be the signal immediately transmitted by the call manager 513 and may be the signal again retransmitted by the access node 515. In this case, the connection response signals 525 and 526 may also be the signal immediately transmitted by the receiving terminal 516 and may be the signal again retransmitted by the access node 515.

The first step may include a step of establishing the number of paths between the transmitting terminal 511 and the receiving terminal 516 within the range of numbers permitted by the call manger 513 (612) and transmitting the first connection request signal 521 including the identifier of the transmitting terminal 511, the identifier of the receiving terminal 516, and the set number to the call manger 513 (614).

The second step may include after the call manger 513 receives the first connection request signals, selecting the plurality of bridges according to the number of request bridges if the first connection request signals 521 and 522 are legal, transmitting the second connection request signals 523 and 524 including the identifier of the transmitting terminal 511 and the identifiers of the plurality of selected bridges 514_1, . . . , 514_{—}n to the receiving terminal 516, and rejecting the connection request signal if it is determined that the first connection request signals 521 and 522 are illegal.

The second step may further include transmitting the relay request signals 531_1, . . . , 531_{—}n to each of the selected bridges 514_1, . . . , 514_{—}n and receiving the relay response signals 532_1, . . . , 532_{—}n from each of the selected bridges 514_1, . . . , 514_{—}n after the call manager 513 selects the plurality of bridges 514_1, . . . , 514_{—}n according to the number of request bridges.

In addition, the second step may further include the call manger 513 receiving the connection request signals 521 and 522 including the identifier of the transmitting terminal 516, the identifier of the receiving terminal 511, and the number of bridges, the call manager 513 selecting the bridges according to the number of bridges to transmit the relay request signals 531_1, . . . , 531_{—}n to the selected bridges 514_1, . . . , 514_{—}n, the bridges 514_1, . . . , 514_{—}n transmitting the relay response signals 531_1, . . . , 532_{—}n to the call manger 513, confirming whether the call manager 513 receives the relay response signals 532_1, . . . , 532_{—}n from all the selected bridges 514_1, . . . , 514_{—}n, the call manager 513 transmitting the second connection request signals 523 and 524 to the receiving terminal 516, the call manager 513 receiving the connection response signals 525 and 526 from the receiving terminal 516, and the call manager 513 transmitting the connection response signals 527 and 528 to the transmitting terminal 511.

The fourth step allows the receiving terminal 516 to transmit the connection response signals 525 and 526 to the call manager 513 and the call manager 513 to transmit the connection response signals 527 and 528 to the transmitting terminal 511. The connection response signals 527 and 528, which are the signal transmitted to the transmitting terminal 511 by the call manager 513, may include the signal transmitted to the access node 512 and the signal transmitted to the transmitting terminal 511.

The rearrangement at the fourth step allows the receiving terminal 511 to randomly arrange the sequence of the bridges 514_1, . . . , 514_{—}n present in the relay requesting signals 523 and 524.

The connection response signals 525 and 526 may include the identifier of the transmitting terminal 511, the identifier of the receiving terminal 516, and the identifier of the rearranged bridges.

The fourth step may include allowing the transmitting terminal 511 to store the information on the identifiers of the rearranged bridges in the round table in sequence and the receiving terminal 516 to store the information on the identifier of the rearranged bridges in the round table in sequence.

Another embodiment of the present invention may be a data transmitting method including: allowing the transmitting terminal 511 to input the data to be transmitted in the buffer (623), sequentially dividing and fetching the data stored in the buffer into the pieces having the defined size between the transmitting terminal 511 and the receiving terminal 516 (626), sequentially fetching the identifier information of the bridges 514_1, . . . , 514_{—}n transmitting the pieces from the round table included in the transmitting terminal 511 (627), and generating the packets including one of the pieces, the identifier of the transmitting terminal, and the identifiers of the bridges fetched from the round table and transmitting the packets in a random sequence (628 and 632).

After the transmitting (628 and 632), the data transmitting method may further include: testing whether data to be transmitted by the transmitting terminal 511 further remain (633); again performing from the inputting to the buffer (637) when the data information remain as the test result, determining whether the connection is released when the data information does not remain (634), transmitting the connection release request signals 561 and 562 to the call manager 553 when the connection is released, and performing from the testing (633) when the connection is not released.

Another embodiment of the present invention may be a data receiving method including: setting the timer so that the receiving terminal 516 can receive all the packets transmitted by the bridges 514_1, . . . , 514_{—}n once and preparing the receiving buffer; receiving the packets including the identifier of the transmitting terminal 511, the identifiers of the bridges, and the data pieces; deriving the bridge identifiers from the received packets and recognizing the bridge identifiers of the received data through the round table included in the receiving terminal 516; storing the data pieces in th receiving buffer according to the bridge identifier; confirming whether all the packets corresponding to the bridge identifier stored in the round table are received; and outputting the data stored in the receiving buffer.

After the outputting, the data receiving method may further include transmitting the connection release response signals 565 and 566 including the identifier of the receiving terminal 516 and the identifier of the transmitting terminal 511 when the receiving terminal 516 receives the connection release request signals 563 and 564 and ending the reception from the transmitting terminal 511.

Another embodiment of the present invention may be a method for releasing a data transmission path including: the first terminal 551 transmitting the connection release request signals 561 and 562 to the call manager 553; the call manager 553 transmitting the connection release request signals 563 and 564 to the second terminal 556; the second terminal 556 transmitting the connection release response signals 565 and 566 to the call manager 553; after the call manager 553 receives the connection release response signals 565 and 566, transmitting the connection release response signals 567 and 568 to the first terminal 551; the call manager 553 transmitting the relay release request signals 571_1, . . . , 571_{—}n to each of the bridges 554_1, . . . , 554_{—}n providing the data moving path between the first terminal 551 and the second terminal 556; and the bridges 554_1, . . . , 554_{—}n transmitting the relay release response signals 572_1, . . . , 572_{—}n to the call manager 553.

Another embodiment of the present invention may be a method for establishing a data path including: the transmitting terminal 1010 previously registering the identifier of the receiving terminal 1016 corresponding to the number of bridges in the call manager 1013; the transmitting terminal 1011 transmitting the first connection request signals 1021 and 1022 including its own identifier and the number of request bridges to the call manager 1013, the call manager 1013 selecting the bridges corresponding to the number of bridges to transmit the relay request signals 1031_1, . . . , 1031_{—}n to the bridges 1014_1, . . . , 1014_{—}n, th bridges 1014_1, . . . , 1014-n receiving the relay request signals 1031_1, . . . 1031_{—}n to transmit the relay response signals 1032_1, . . . , 1032_{—}n to the call manager 1013, the call manager 1013 transmitting the second connection request signals 1023 and 1024 including the identifier of the receiving terminal 1016 and the identifier of each of the bridges transmitting the relay response signals 1032_1, . . . , 1032_{—}n to the receiving terminal 1016; the receiving terminal 1016 rearranging the identifiers of the bridges 1014_1, . . . , 1014_{—}n to transmit the connection response signals 1025 and 1026 to the call manager 1013; the call manager 1013 transmitting the connection response signals 1027 and 1028 including the identifier of the transmitting terminal 1011 and the identifier of the rearranged bridges to the transmitting terminal 1011.

The first connection request signals 1021 and 1022, which are the signals transmitted to the call manager 1013 by the transmitting terminal 1011, may include the signal 1021 transmitted to the access node 1012 and the signal 1022 transmitted to the call manager 1013.

The second connection request signals 1023 and 1022, which are the signals transmitted to the receiving terminal 1016 by the call manager 1013, may include the signal 1023 transmitted to the access node 1015 and the signal 1024 transmitted to the receiving terminal 1016.

The connection response signals 1025 and 1026, which are the signals transmitted to the call manager 1013 by the receiving terminal 1016, may include the signal 1025 transmitted to the access node 1015 and the signal 1026 transmitted to the call manager 1013.

The connection response signals 1027 and 1028, which are the signals transmitted to the transmitting terminal 1011 by the call manager 1013, may include the signal 1027 transmitted to the access node 1012 and the signal 1028 transmitted to the transmitting terminal 1011.

Another embodiment of the present invention may be a method for releasing a data transmission path including: the transmitting terminal previously registering the identifiers of the receiving terminal corresponding to the number of bridges in the call manager 1153; the first terminal 1151 transmitting the connection release request signals 1161 and 1162 including its own identifier and the identifiers of each bridge 154_1, . . . , 1154_{—}n to the call manager 1153; the call manager 1153 transmitting the connection release request signals 1163 and 1164 to the second terminal 1156; the second terminal 1156 transmitting the connection release response signals 1156 and 1166 to the call manager 1153; the call manager 1153 transmitting the connection release response signals 1167 and 1168 to the first terminal 1151; the call manager 1153 transmitting the relay release request signals 1171_1, . . . , 1172_{—}n to the bridges 1154_1, . . . , 1154_{—}n; each bridge 1154_1, . . . , 1154_{—}n receiving the relay release request signals 1171_1, . . . , 1171_{—}n transmitting the relay release response signals 1172_1, . . . , 1172_{—}n to the call manager 1153.

The connection release request signals 1161 and 1062, which are the signals transmitted to the call manager 1053 by the first terminal 1151, may include the signal 1161 transmitted to the access node 1152 and the signal 1162 transmitted to the call manager 1153.

The connection release request signals 1163 and 1164, which are the signals transmitted to the second terminal 1156 by the call manager 1153, may include the signal 1163 transmitted to the access node 1155 and the signal 1164 transmitted to the second terminal 1156.

The connection release request signals 1165 and 1166, which are the signals transmitted to the call manager 1053 by the second terminal 1156, may include the signal 1165 transmitted to the access node 1155 and the signal 1166 transmitted to the call manager 1153.

The connection release request signals 1167 and 1168, which are the signals transmitted to the first terminal 1151 by the call manager 1153, may include the signal 1167 transmitted to the access node 1152 and the signal 1168 transmitted to the first terminal 1151.

Another embodiment of the present invention may be a method for changing the number of bridges and paths including: the first terminal 1211 transmitting the bridge change request signal 1221 to the call manager 1213; the call manager 1213 selecting new bridges and then transmitting the bridge change request signals 1223 to the second terminal 126; the second terminal 1216 transmitting the bridge change response signals 1226 and 1228 to the first terminal 1211 through the call manager 1213; the first terminal 1211 transmitting the bridge change response receiving signals 1241 and 1242 to the second terminal 1216 through the call manager 1213; and starting the data transmission through the changed bridges.

According to the embodiment of the present invention, when generating and transmitting the address/identification number and the number of any relay nodes of the terminal/node connected to the terminal/node to be first connected, the network sets the actual relay bridges of the requested numbers and transmits the set relay bridges to the terminal/node and when the terminal/node divides and transmits the voice/data to the terminal/node through the network, the terminal/node may divide and transmit the voice/data into pieces by the method determined by the terminal/node. Therefore, the bridges in the network serve as the terminal/node and the virtual terminal/node that transmits and receives to and from the terminal/node. The above-mentioned method my use the existing transmission device and the network and the third terminal/node can appreciate the transmitting and receiving contents even though being exposed to the third terminal/node at the intermediate portion of the network and the existing information protective method may be applied as it is.

The embodiment may include comparing the connection response signal prior to be changed stored in the call manager with the bridges of the bridge change connection response signal; transmitting the relay release request signal to the bridges that is not present in the bridge change connection response signal among the bridges of the stored connection response signal; transmitting the relay release response signal by the bridges that are not included in the bridge change connection response signals; the call manager replacing the bridge information stored in the call manager with the bridge information included in the bridge change response signal.

As set forth above, the exemplary embodiments of the present invention can implement the safe communication by encrypting the transfer path of the voice/data information even in the state in which the subscriber terminals/nodes do not know the internal information of the network. In addition, the exemplary embodiments of the present invention can be applied even in the state in which the existing information protection method and apparatus are used as they are and can also be applied to the existing commercial network.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A network system, comprising:
a transmitting terminal configured to divide and transmit data into a plurality of data pieces;
a plurality of bridges configured to receive the plurality of data pieces and transmit the divided data pieces to a receiving terminal; and
a call manager configured to manage communication among the transmitting terminal, the receiving terminal, and the plurality of bridges,
wherein the bridges use the same identifier systems as the transmitting terminal and the receiving terminal.

2. The network system of claim 1, wherein the call manager selects the plurality of bridges among the bridges present in the network system according to the number requested by the transmitting terminal.

3. The network system of claim 1, wherein each of the plurality of data pieces has a correspondence relation corresponding to any one of the plurality of bridges and the receiving terminal recovers the data from the plurality of data pieces based on the correspondence.

4. The network system of claim 1, wherein a sequence in which the plurality of data pieces and the plurality of bridges correspond to each other is determined by the receiving terminal.

5. The network system of claim 1, wherein an address of the receiving terminal is previously stored in the call manager and the signal transmitted from the transmitting terminal to the call manager does not include the address of the receiving terminal and the signal transmitted from the receiving terminal to the call manager does not include the address of the transmitting terminal.

6. A user device, comprising:
a communication unit that allows wireless and wired communication with a network; and
a processor configured to process data to be transmitted through the communication unit,
wherein the processor is included in the network and is configured to receive information on a plurality of bridges using the same address system as the user device through the communication unit and is configured to divide the data into a plurality of data pieces and transmit the divided data pieces to the plurality of bridges, and
the plurality of data pieces are configured to be transmitted to the receiving terminal by the plurality of bridges.

7. A user device, comprising:
a communication unit that allows wireless and wired communication within a network; and
a processor configured to process data to be transmitted through the communication unit,
wherein the processor is included in the network and is configured to receive information on a plurality of bridges using the same address system as the user device through the communication unit and after receiving a plurality of data pieces from the plurality of bridges, is configured to recover the data by combining the plurality of received data pieces.

8. The user device of claim 7, wherein before the user device receives the plurality of data pieces from the plurality of bridges, the user device randomly rearranges a sequence of the information on the plurality of bridges and transmits the information to the network and a process of combining the plurality of data pieces is executed according to a rearrangement sequence.

9. A call processing device, comprising:
a communication unit that allows wireless and wired communication within a network; and
a processor configured to process transmitting data and receiving data transmitted and received through the communication unit,
wherein the processor is configured to select a plurality of bridges from the network according to the number of bridges requested from a first user device and transmit the information on the plurality of selected bridges to a second user device, and
the plurality of bridges use the same address systems as the address systems of the first user device and the second user device.

10. A network bridge, comprising:
a communication unit that allows wireless and wired communication within a network; and
a processor configured to process transmitting data and receiving data transmitted and received through the communication unit,
wherein the processor is configured to receive information on a first user device and a second user device using the same address system as a network bridge from the network and is configured to receive data pieces from the first user device and transmit the received data pieces to the second user device.
